(19) United States
(12) Patent Application Publication
(10) Pub. No.: US 2025/0242249 A1
(43) Pub. Date: Jul. 31, 2025

(54) ONE OR MORE NON-TRANSITORY COMPUTER-READABLE MEDIA, INFORMATION PROCESSING SYSTEM, INFORMATION PROCESSING APPARATUS, AND INFORMATION PROCESSING METHOD

(71) Applicant: NINTENDO CO., LTD., Kyoto (JP)

(72) Inventor: Yusuke KITAZONO, Kyoto (JP)

(21) Appl. No.: 19/005,940

(22) Filed: Dec. 30, 2024

(30) Foreign Application Priority Data
Jan. 30, 2024 (JP) 2024-011590

(51) Int. Cl. A63F 13/55; G06T 15/00

(52) U.S. Cl. CPC A63F 13/55; G06T 15/005

(57) ABSTRACT

An example of an information processing system can move a player character on a terrain object formed based on voxel data, and if a destruction action of the player character hits the terrain object, sets a destruction range that is a range set in accordance with a position of the player character and has a shape obtained by excluding from a predetermined shape a range below a predetermined surface set based on the position of the player character. The information processing system updates set the voxel data of a voxel included in the destruction range to a value indicating that the terrain object is not present, and creates a polygon mesh based on the updated voxel data.

### CROSS REFERENCE TO RELATED APPLICATION

This application claims priority to Japanese Patent Application No. 2024-011590 filed on Jan. 30, 2024, the entire contents of which are incorporated herein by reference.

### FIELD

The present disclosure relates to a non-transitory computer-readable storage medium having stored therein a game program, an information processing system, an information processing apparatus, and an information processing method that are capable of generating an image using voxels.

### BACKGROUND AND SUMMARY

In the prior art, there is a game where character voxels are created based on image capturing information, and polygon mesh information is generated.

In the above prior art, however, voxels are used to generate an object based on the image capturing information, and the object is not deformed by updating voxel data.

Therefore, an exemplary embodiment discloses a non-transitory computer-readable storage medium having stored therein a game program, an information processing system, an information processing apparatus, and an information processing method that are capable of causing a player character to perform an action with a high degree of freedom while deforming an object with a high degree of freedom in a game where voxels are used.

The exemplary embodiment employs the following configurations.

One or more non-transitory computer-readable media are one or more non-transitory computer-readable media having stored therein instructions that, when executed, cause one or more processors of an information processing apparatus to execute image processing including: storing, in a memory, first volume data that is data for representing a first object in a virtual space and holds voxel data indicating presence of an object with respect to each voxel included in a first voxel space placed in the virtual space. The image processing further includes: moving a player character on the first object based on an operation input of a player; and causing the player character to perform a destruction action based on an operation input of the player. The image processing further includes: if the destruction action hits the first object, updating the voxel data of a voxel included in a first erasure range to a value indicating that an object is not present, the first erasure range being a range set in accordance with a position of the player character and having a shape obtained by excluding from a predetermined shape a range below a predetermined surface set based on the position of the player character; and based on the first volume data, at least drawing a polygon mesh representing a surface of the first object, thereby generating an image of the virtual space.

Based on the above, a player character is moved on a first object and also caused to perform a destruction action, and if the destruction action hits the first object, voxel data of a voxel included in a first erasure range having a shape obtained by excluding a range below the predetermined surface from a predetermined shape is updated, whereby it is possible to destroy the first erasure range in the first object. Consequently, it is possible to cause the shape of the first object after the destruction to be a shape having the predetermined surface relating to the position of the player character, and it is possible to cause the player character to perform an action with a high degree of freedom while deforming the object with a high degree of freedom. For example, it is possible to cause the shape of the first object after the destruction to be a flat surface, and it is possible to make it easy for the player character to move on the first object after the destruction.

Further, the destruction action may be a destruction action in a front direction of the player character. The first erasure range may be set in front of the player character when the destruction action hits the first object. The predetermined surface may be a horizontal plane having a height of a ground with which the player character is in contact when the destruction action hits the first object.

Based on the above, if the destruction action in the front direction hits the first object, the predetermined surface can be a horizontal plane having the same height as that of the ground. Consequently, it is possible to cause the first object after the destruction to be a horizontal plane having the same height as that of the ground, and it is possible to make it easy for the player character to move on the first object after the destruction.

Further, the image processing may further include, if the destruction action hits the first object, setting a height of the predetermined surface based on the position of the player character. If the entirety of the predetermined shape is located above the predetermined surface, the first erasure range may be the predetermined shape.

Based on the above, the height of the predetermined surface is set based on the position of the player character when the destruction action hits the first object. If the entirety of the predetermined shape is located above the predetermined surface, e.g., if the predetermined shape is not present below the predetermined surface, the first erasure range can be set as the predetermined shape. It is possible to dynamically set the height of the predetermined surface based on the position of the player character and set the first erasure range.

Further, the destruction action may be a destruction action in a front direction of the player character. The first erasure range may be set in front of the player character when the destruction action hits the first object. If the player character is in the air when the destruction action hits the first object, the predetermined surface may be a horizontal plane having a height of a ground located below the player character.

Based on the above, even if the destruction action hits the first object when the player character is in the air, a horizontal plane at the height of the ground located below the player character can be set as the predetermined surface. Consequently, it is possible to make it easy for the player character to move on the first object after the player character lands.

Further, the destruction action may be a destruction action in an obliquely upward direction of the player character. The first erasure range may be set in the obliquely upward direction of the player character when the destruction action hits the first object. The predetermined surface may be a slope which passes through a position on a ground with which the player character is in contact when the destruction action hits the first object, and in which the further in a forward direction of the player character the slope is, the higher the slope is.

Based on the above, if the player character is caused to perform the destruction action in an obliquely upward direction, the predetermined surface can be a slope. Consequently, for example, it is possible to set the predetermined surface along the direction of the destruction action, and make the shape of the first object after the destruction along the direction of the destruction action.

Further, the predetermined shape may be any of a sphere, an ellipsoidal body, and a shape obtained by asymmetrically deforming an ellipsoidal body.

Based on the above, it is possible to cause at least a part of the first erasure range to be a curved surface, and it is possible to cause the shape of the first object after the destruction to be a natural shape.

Further, the image processing may further include, if a ground with which the player character is in contact when the destruction action hits the first object is tilted to a horizontal plane, setting the predetermined surface tilted to the horizontal plane.

Based on the above, if the ground with which the player character is in contact is tilted, it is possible to also tilt the predetermined surface. Thus, it is possible to tilt the ground in the periphery of the player character after the destruction similarly to another portion.

Further, the image processing may further include storing, in the memory, second volume data that is data for representing a second object in the virtual space and holds the voxel data with respect to each voxel included in a second voxel space placed in the virtual space. The image processing may further include, if the destruction action hits the second object, updating the voxel data of a voxel included in a second erasure range that is a range set in accordance with the position of the player character, has a shape obtained by excluding from a predetermined shape a range below a predetermined surface set based on the position of the player character, and is different in size from the first erasure range to a value indicating that an object is not present. The image processing may further include further drawing a polygon mesh representing a surface of the second object based on the second volume data, thereby generating an image of the virtual space.

Based on the above, even if the destruction action is performed on a second object, it is possible to set a second erasure range having a shape obtained by excluding from a predetermined shape a range below a predetermined surface set based on the position of the player character. The second erasure range is different in size from the first erasure range, and therefore, it is possible to vary a range to be destroyed between the first object and the second object.

Further, a single voxel included in the first volume data and a single voxel included in the second volume data may be different from each other in size defined in the virtual space.

Based on the above, for example, it is possible to make the size of a single voxel included in second volume data smaller than the size of a single voxel included in first volume data. Consequently, for example, it is possible to represent the second object with a higher resolution than the first object.

Further, the image processing may further include: causing the player character to perform a destruction action in a down direction based on an operation input of the player, and if the destruction action in the down direction hits the first object, updating the voxel data of a voxel included in a third erasure range set below the player character to a value indicating that the first object is not present.

Based on the above, if the destruction action in the down direction of the player character hits the first object, it is possible to set a third erasure range below the player character and update voxel data of a voxel included in the third erasure range. For example, if the destruction action in the down direction is performed, it is possible to destroy the third erasure range set in advance.

Further, the first object may be a terrain in the virtual space.

Based on the above, it is possible to cause the player character to perform the destruction action on a terrain and destroy the terrain.

Further, the image processing may further include determining a vertex position of a polygon based on the voxel data between a voxel in which the first object is not present and a voxel in which the first object is present, thereby generating the polygon mesh. The image processing may further include, if the voxel data of a voxel included in the first erasure range is updated, recalculating a vertex of the polygon mesh in a range including a voxel in which at least the voxel data is updated.

Based on the above, it is possible to generate a polygon mesh based on the voxel data and recalculate a vertex position of a polygon by updating the voxel data. Consequently, it is possible to change the shape of an object with a high degree of freedom.

Another exemplary embodiment may be an information processing system that executes the above game program, or may be an information processing apparatus, or may be an information processing method.

According to the exemplary embodiment, it is possible to cause the shape of a first object after destruction to be a shape having a predetermined surface relating to the position of the player character. Thus, it is possible to deform an object with a high degree of freedom while causing the player character to perform an action with a high degree of freedom.

These and other features, aspects and advantages of the subject matter described herein will become more apparent from the following detailed description of the exemplary embodiments when taken in conjunction with the accompanying drawings.

### BRIEF DESCRIPTION OF THE DRAWINGS

FIG. 1 is an illustrative non-limiting diagram showing an example of the state where a left controller 3 and a right controller 4 are attached to a main body apparatus 2;

FIG. 2 is an illustrative non-limiting diagram showing an example of the state where each of the left controller 3 and the right controller 4 is detached from the main body apparatus 2;

FIG. 3 is illustrative non-limiting six orthogonal views showing an example of the main body apparatus 2;

FIG. 4 is illustrative non-limiting six orthogonal views showing an example of the left controller 3;

FIG. 5 is illustrative non-limiting six orthogonal views showing an example of the right controller 4;

FIG. 6 is an illustrative non-limiting block diagram showing an example of the internal configuration of the main body apparatus 2;

FIG. 7 is an illustrative non-limiting block diagram showing an example of the internal configurations of the main body apparatus 2, the left controller 3, and the right controller 4;

FIG. 8 is an example non-limiting diagram showing an example of a terrain object as a voxel object;

FIG. 9 is an example non-limiting diagram showing examples of the states before and after a part of the terrain object shown in FIG. 8 is deleted;

FIG. 10 is an example non-limiting diagram showing examples of the states before and after a part of the terrain object shown in FIG. 8 is deleted;

FIG. 11 is an example non-limiting diagram showing an example of the content of voxel data;

FIG. 12 is an example non-limiting diagram showing an example of property information indicating the property of a material;

FIG. 13 is an example non-limiting diagram showing an example of texture information indicating the texture of a material;

FIG. 14 is an example non-limiting diagram showing an example of a method for generating a mesh;

FIG. 15 is an example non-limiting diagram showing an example of a game image including a terrain object;

FIG. 16 is an example non-limiting diagram showing an overall schematic diagram of a game space in a game according to the exemplary embodiment;

FIG. 17 is an example non-limiting diagram showing an example of the state where a destruction action is performed by a player character;

FIG. 18 is an example non-limiting diagram showing an example of a destruction range in a case where a first shape is not corrected and terrain objects after destruction in the destruction range;

FIG. 19 is an example non-limiting diagram showing an example of the destruction range in a case where a first shape is corrected and the terrain objects after the destruction in the destruction range;

FIG. 20 is an example non-limiting diagram showing an example of the destruction range set when the player character PC throws a punch in the front direction in a case where the ground with which the player character PC is in contact is tilted;

FIG. 21 is an example non-limiting diagram showing an example of a calculation method for calculating the tilt of the ground with which the player character PC is in contact;

FIG. 22 is an example non-limiting diagram showing an example where the destruction range is corrected in a case where the player character PC throws a punch in the front direction when being in the air, and the punch hits the terrain object 220;

FIG. 23 is an example non-limiting diagram showing an example where the destruction range is not corrected in a case where the player character PC throws a punch in the front direction when being in the air, and the punch hits the terrain object 220;

FIG. 24 is a diagram in which the destruction range before correction and the destruction range after the correction are compared with each other, and is an example non-limiting diagram showing an example of the destruction range in a case where the player character PC throws a punch in an obliquely upward direction;

FIG. 25 is a diagram in which a case where the destruction range is not corrected and a case where the destruction range is corrected are compared with each other, and is an example non-limiting diagram showing an example of the terrain after the destruction in a case where the player character PC throws successive punches in the obliquely upward direction;

FIG. 26 is an example non-limiting diagram showing an example of the destruction range set in a case where the player character PC throws a punch in the down direction;

FIG. 27 is an example non-limiting diagram showing an example of the terrain after a terrain object is destroyed in the destruction range set in a case where the player character PC throws a punch in the down direction;

FIG. 28 is an example non-limiting diagram showing an example of a voxel object other than the terrain objects 210 and 220 placed in the game space;

FIG. 29 is an example non-limiting diagram showing examples of various pieces of data used in information processing by a game system 1;

FIG. 30 is an example non-limiting flow chart showing an example of the flow of game processing executed by the game system 1; and

FIG. 31 is an example non-limiting flow chart showing an example of a destruction range setting process in step S6.

### DETAILED DESCRIPTION OF NON-LIMITING EXAMPLE EMBODIMENTS

### [1. Configuration of Game System]

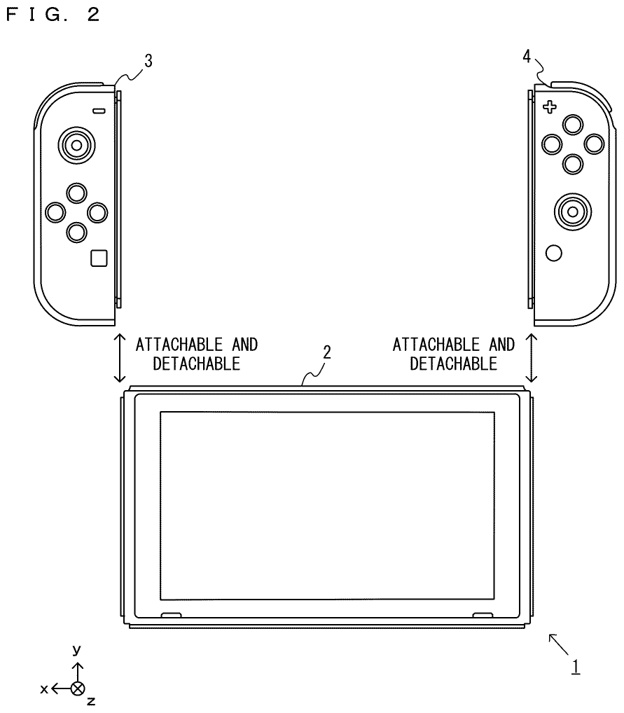

A game system according to an example of an exemplary embodiment is described below. An example of a game system 1 according to the exemplary embodiment includes a main body apparatus (an information processing apparatus; which functions as a game apparatus main body in the exemplary embodiment) 2, a left controller 3, and a right controller 4. Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2. Further, in the game system 1, the main body apparatus 2, the left controller 3, and the right controller 4 can also be used as separate bodies (see FIG. 2). Hereinafter, first, the hardware configuration of the game system 1 according to the exemplary embodiment is described, and then, the control of the game system 1 according to the exemplary embodiment is described.

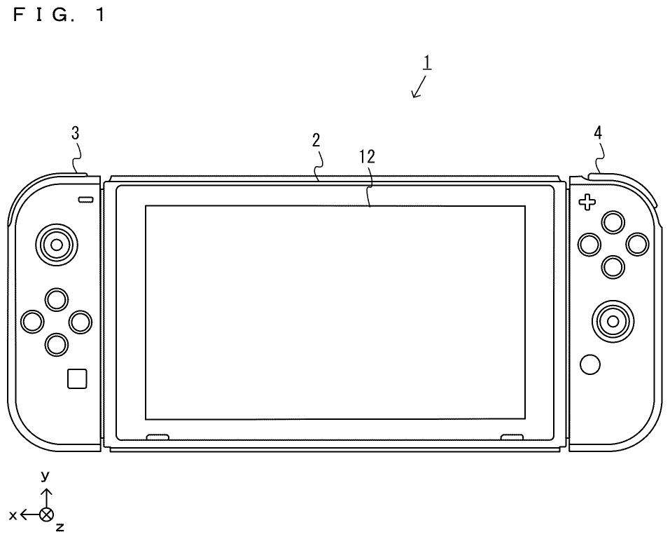

FIG. 1 is a diagram showing an example of the state where the left controller 3 and the right controller 4 are attached to the main body apparatus 2. As shown in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

FIG. 2 is a diagram showing an example of the state where each of the left controller 3 and the right controller 4 is detached from the main body apparatus 2. As shown in FIGS. 1 and 2, the left controller 3 and the right controller 4 are attachable to and detachable from the main body apparatus 2. It should be noted that hereinafter, the left controller 3 and the right controller 4 will occasionally be referred to collectively as a “controller”.

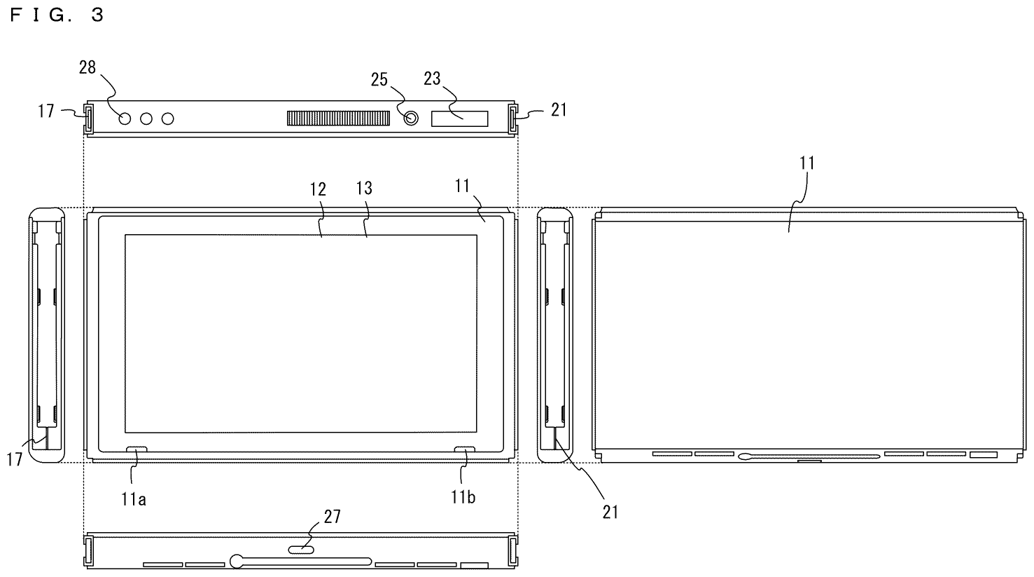

FIG. 3 is six orthogonal views showing an example of the main body apparatus 2. As shown in FIG. 3, the main body apparatus 2 includes an approximately plate-shaped housing 11. In the exemplary embodiment, a main surface (for example, a surface on a front side, such as a surface on which the display 12 is provided) of the housing 11 has a generally rectangular shape.

It should be noted that the shape and the size of the housing 11 are optional. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As shown in FIG. 3, the main body apparatus 2 includes the display 12, which is provided on the main surface of the housing 11. The display 12 displays an image generated by the main body apparatus 2. In the exemplary embodiment, the display 12 is a liquid crystal display device (LCD). The display 12, however, may be a display device of any type.

Further, the main body apparatus 2 includes a touch panel 13 on a screen of the display 12. In the exemplary embodiment, the touch panel 13 is of a type that allows a multi-touch input (e.g., a capacitive type). The touch panel 13, however, may be of any type. For example, the touch panel 13 may be of a type that allows a single-touch input (e.g., a resistive type).

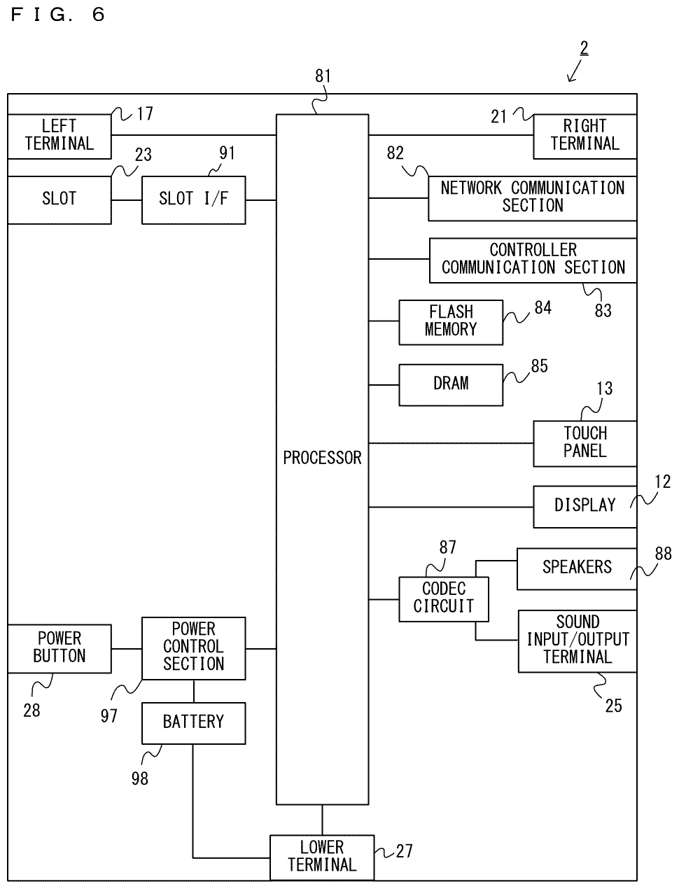

The main body apparatus 2 includes speakers (e.g., speakers 88 shown in FIG. 6) within the housing 11. As shown in FIG. 3, speaker holes 11a and 11b are formed on the main surface of the housing 11. Then, sounds output from the speakers 88 are output through the speaker holes 11a and 11b.

Further, the main body apparatus 2 includes a left terminal 17, which is a terminal for the main body apparatus 2 to perform wired communication with the left controller 3, and a right terminal 21, which is a terminal for the main body apparatus 2 to perform wired communication with the right controller 4.

As shown in FIG. 3, the main body apparatus 2 includes a slot 23. The slot 23 is provided on an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower terminal 27. The lower terminal 27 is a terminal for the main body apparatus 2 to communicate with a cradle. In the exemplary embodiment, the lower terminal 27 is a USB connector (more specifically, a female connector). Further, when the unified apparatus or the main body apparatus 2 alone is mounted on the cradle, the game system 1 can display on a monitor an image generated by and output from the main body apparatus 2. The monitor may be stationary or may be movable. Further, in the exemplary embodiment, the cradle has the function of charging the unified apparatus or the main body apparatus 2 alone mounted on the cradle. Further, the cradle has the function of a hub device (specifically, a USB hub).

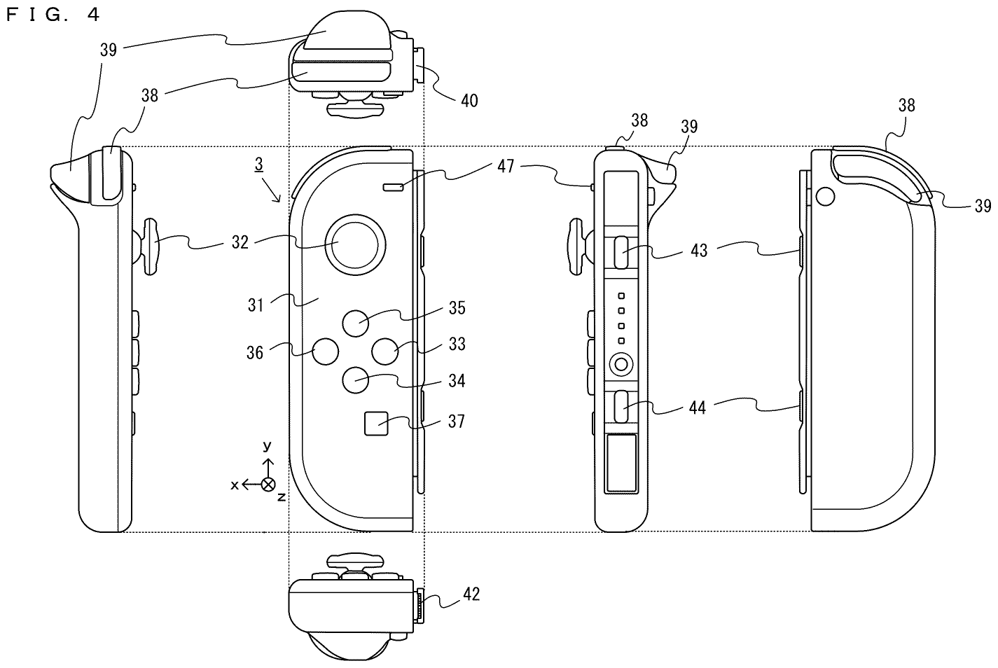

FIG. 4 is six orthogonal views showing an example of the left controller 3. As shown in FIG. 4, the left controller 3 includes a housing 31. In the exemplary embodiment, the housing 31 has a vertically long shape. The housing 31 may be shaped to be long in an up-down direction. For example, along the y-axis direction shown in FIGS. 1 and 4. In the state where the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly the left hand. Further, the left controller 3 can also be held in the orientation in which the left controller 3 is horizontally long. When held in the orientation in which the left controller 3 is horizontally long, the left controller 3 may be held with both hands.

The left controller 3 includes an analog stick 32. As shown in FIG. 4, the analog stick 32 is provided on a main surface of the housing 31. The analog stick 32 can be used as a direction input section with which a direction can be input. The user tilts the analog stick 32 and thereby can input a direction corresponding to the direction of the tilt (and input a magnitude corresponding to the angle of the tilt). It should be noted that the left controller 3 may include a directional pad, a slide stick that allows a slide input, or the like as the direction input section, instead of the analog stick. Further, in the exemplary embodiment, it is possible to provide an input by pressing the analog stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give instructions depending on various programs (e.g., an operating system (OS) program and an application program) executed by the main body apparatus 2.

Further, the left controller 3 includes a terminal 42 for the left controller 3 to perform wired communication with the main body apparatus 2.

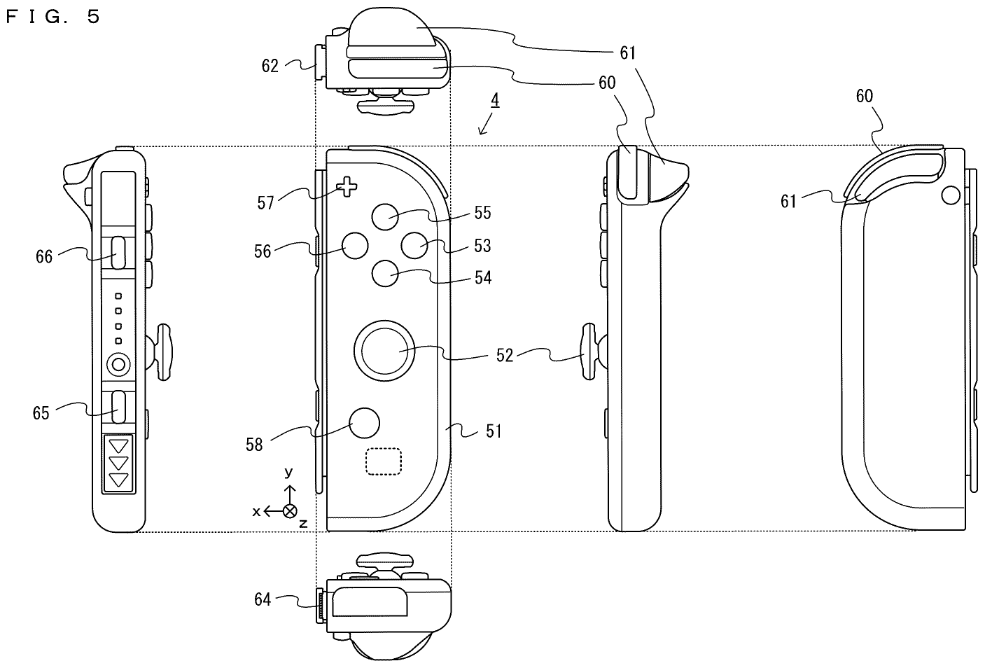

FIG. 5 is six orthogonal views showing an example of the right controller 4. As shown in FIG. 5, the right controller 4 includes a housing 51. In the exemplary embodiment, the housing 51 has a vertically long shape. For example, it may be shaped to be long in the up-down direction. In the state where the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes an analog stick 52 as a direction input section. In the exemplary embodiment, the analog stick 52 has the same configuration as that of the analog stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for the right controller 4 to perform wired communication with the main body apparatus 2.

FIG. 6 is a block diagram showing an example of the internal configuration of the main body apparatus 2. The main body apparatus 2 includes components 81 to 91, 97, and 98 shown in FIG. 6 in addition to the components shown in FIG. 3. Some of the components 81 to 91, 97, and 98 may be mounted as electronic components on an electronic circuit board and accommodated in the housing 11.

The main body apparatus 2 includes a processor 81. The processor 81 is an information processing section for executing various types of information processing to be executed by the main body apparatus 2. For example, the processor 81 may be composed only of a CPU (Central Processing Unit), or may be composed of a SoC (System-on-a-chip) having a plurality of functions such as a CPU function and a GPU (Graphics Processing Unit) function. The processor 81 executes an information processing program (e.g., a game program) or other instructions that are stored in storage. For example, in an internal non-transitory storage medium such as a flash memory 84, an external storage non-transitory medium attached to the slot 23, or the like), thereby performing the various types of information processing.

The main body apparatus 2 includes a flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing. DRAM 85 and flash memory 84 are illustrative non-limiting examples of non-transitory computer-readable media.

The main body apparatus 2 includes a slot interface (hereinafter abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the exemplary embodiment, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined communication method (e.g., communication based on a unique protocol or infrared light communication). It should be noted that the wireless communication in the above second communication form achieves the function of enabling so-called “local communication” in which the main body apparatus 2 can wirelessly communicate with another main body apparatus 2 placed in a closed local network area, and the plurality of main body apparatuses 2 directly communicate with each other to transmit and receive data.

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2 and the left controller 3 and the right controller 4 is optional. In the exemplary embodiment, the controller communication section 83 performs communication compliant with the Bluetooth (registered trademark) standard with the left controller 3 and with the right controller 4.

The processor 81 is connected to the left terminal 17, the right terminal 21, and the lower terminal 27. When performing wired communication with the left controller 3, the processor 81 transmits data to the left controller 3 via the left terminal 17 and also receives operation data from the left controller 3 via the left terminal 17. Further, when performing wired communication with the right controller 4, the processor 81 transmits data to the right controller 4 via the right terminal 21 and also receives operation data from the right controller 4 via the right terminal 21. Further, when communicating with the cradle, the processor 81 transmits data to the cradle via the lower terminal 27. As described above, in the exemplary embodiment, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle, the main body apparatus 2 can output data (e.g., image data or sound data) to the monitor or the like via the cradle.

Here, the main body apparatus 2 can communicate with a plurality of left controllers 3 simultaneously (in other words, in parallel). Further, the main body apparatus 2 can communicate with a plurality of right controllers 4 simultaneously (in other words, in parallel). Thus, a plurality of users can simultaneously provide inputs to the main body apparatus 2, each using a set of the left controller 3 and the right controller 4. As an example, a first user can provide an input to the main body apparatus 2 using a first set of the left controller 3 and the right controller 4, and simultaneously, a second user can provide an input to the main body apparatus 2 using a second set of the left controller 3 and the right controller 4.

Further, the display 12 is connected to the processor 81. The processor 81 displays a generated image (e.g., an image generated by executing the above information processing) and/or an externally acquired image on the display 12.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

The main body apparatus 2 includes a power control section 97 and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 17, and the right terminal 21). Based on a command from the processor 81, the power control section 97 controls the supply of power from the battery 98 to the above components.

Further, the battery 98 is connected to the lower terminal 27. When an external charging device (e.g., the cradle) is connected to the lower terminal 27, and power is supplied to the main body apparatus 2 via the lower terminal 27, the battery 98 is charged with the supplied power.

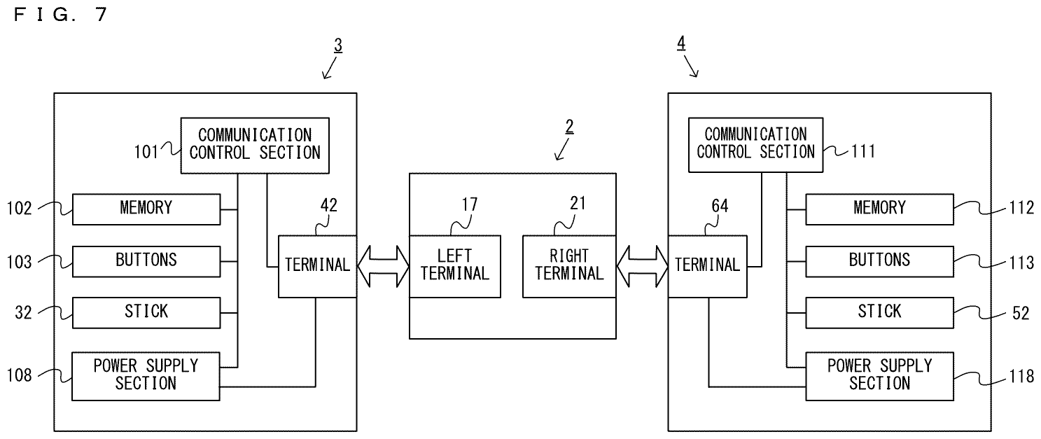

FIG. 7 is a block diagram showing examples of the internal configurations of the main body apparatus 2, the left controller 3, and the right controller 4. It should be noted that the details of the internal configuration of the main body apparatus 2 are shown in FIG. 6 and therefore are omitted in FIG. 7.

The left controller 3 includes a communication control section 101, which communicates with the main body apparatus 2. As shown in FIG. 7, the communication control section 101 is connected to components including the terminal 42. In the exemplary embodiment, the communication control section 101 can communicate with the main body apparatus 2 through both wired communication via the terminal 42 and wireless communication not via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the analog stick (“stick” in FIG. 7) 32. Each of the buttons 103 and the analog stick 32 outputs information regarding an operation performed on itself to the communication control section 101 repeatedly at appropriate timing.

The communication control section 101 acquires information regarding an input (specifically, information regarding an operation or the detection result of the sensor) from each of input sections (specifically, the buttons 103 and the analog stick 32). The communication control section 101 transmits operation data including the acquired information (or information obtained by performing predetermined processing on the acquired information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the analog stick 32 based on the operation data.

The left controller 3 includes a power supply section 108. In the exemplary embodiment, the power supply section 108 includes a battery and a power control circuit. Although not shown in FIG. 7, the power control circuit is connected to the battery and also connected to components of the left controller 3 (specifically, components that receive power supplied from the battery).

As shown in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113 and the analog stick 52. These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

### [2. Outline of Process on Game System]

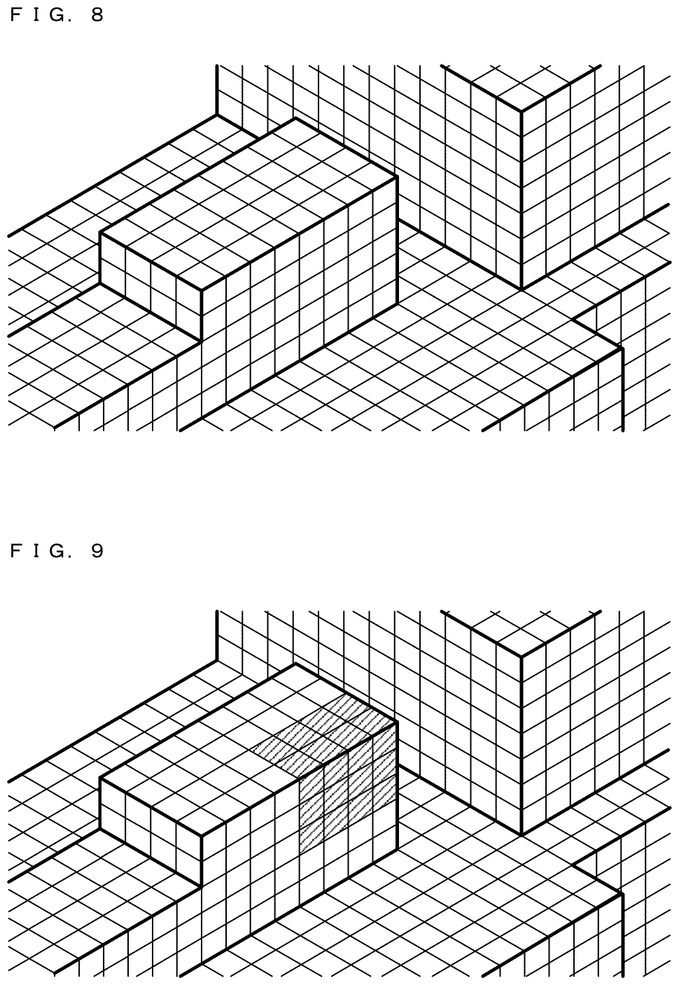

Next, referring to FIG. 8 to FIG. 15, an outline of the process performed on the game system 1 will be described. In the present embodiment, the game system 1 generates a game image in which terrain objects and characters (e.g., the player character controlled by the player) are arranged in a game space, which is a three-dimensional virtual space, and displays the game image on a display device. Note that in the present embodiment, the display device on which the game image is displayed may be the display 12 described above, or may be a monitor.

### [2-1. Voxel]

In the present embodiment, for some objects in the game space, the shape is defined by voxel data. Here, voxels are rectangular parallelepiped (more specifically, cubic) regions arranged in a grid pattern in the game space, and voxel data is data that is set for each voxel. Hereinafter, an object whose shape is defined by voxel data will be referred to as a “voxel object”. In the present embodiment, for each of a plurality of voxels that are set in the game space, the game system 1 stores voxel data as data for generating voxel objects in the game space.

FIG. 8 is a view showing an example of a terrain object, which is a voxel object. As shown in FIG. 8, in the present embodiment, a terrain object representing a terrain such as a ground surface has its shape defined by voxel data. The cubes shown in FIG. 8 represent a terrain object. Note that in FIG. 8, edges of the terrain object are indicated by thick lines. However, these thick lines are added for the purpose of making the drawings easier to understand, and in practice, there is no need for edges of the terrain object to be drawn thick.

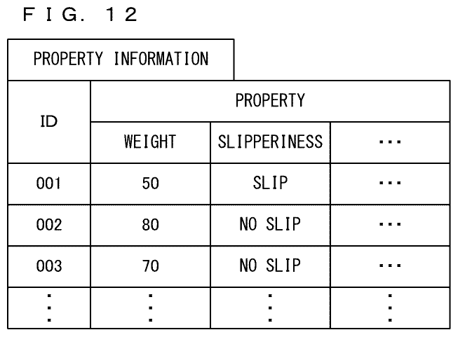

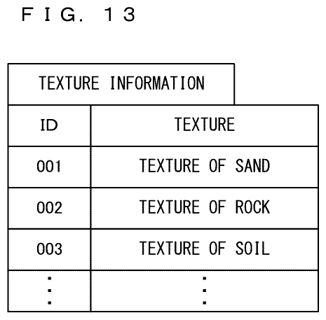

For example, the terrain object shown in FIG. 8 is generated by the following rule: “a cube is placed at the position of a voxel if a parameter included in the voxel data set for the voxel is greater than a predetermined value, and nothing is placed at the position of the voxel if the parameter is less than or equal to the predetermined value”. The terrain object in FIG. 8 is shown for the purpose of illustrating the relationship between voxels and voxel objects in an easy-to-understand manner. In the present embodiment, in practice, a voxel object is generated by such a rule that results in a terrain object having a complicated shape in comparison with the cubic voxels (e.g., based on the voxel data), such as a terrain object shown in FIG. 14 to be described below, for example. Note that there is no limitation on the rule for determining the shape of the voxel object based on the voxel data. In other embodiments, the game system 1 may generate a voxel object as shown in FIG. 8 based on the voxel data or may generate a voxel object as shown in FIG. 15 based on the voxel data.

It is possible to change the shape of a voxel object by changing voxel data of voxels. FIG. 9 and FIG. 10 are views showing before and after the deletion of a portion of the terrain object shown in FIG. 8. That is, when the hatched portion of the terrain object shown in FIG. 9 is destroyed, the terrain object changes to a shape as shown in FIG. 10. In such a case, the game system 1 can easily delete the terrain object by rewriting the voxel data described below so as to indicate that the terrain object is absent for voxels in the hatched portion. Note that also when making an addition to the terrain object, as when deleting the terrain object, the game system 1 can easily change the shape of the terrain object by changing the voxel data of voxels.

Thus, the game system 1 can freely change the shape of a voxel object by rewriting the voxel data. For example, in a case where the shape of a terrain object may be changed as a result of the terrain object in a game being broken for some reason (e.g., the player object striking the terrain object), the game system 1 can freely change the shape of the terrain object by changing the voxel data used to generate the terrain object, rather than directly changing data representing the outer shape of the terrain object (e.g., the mesh to be described below).

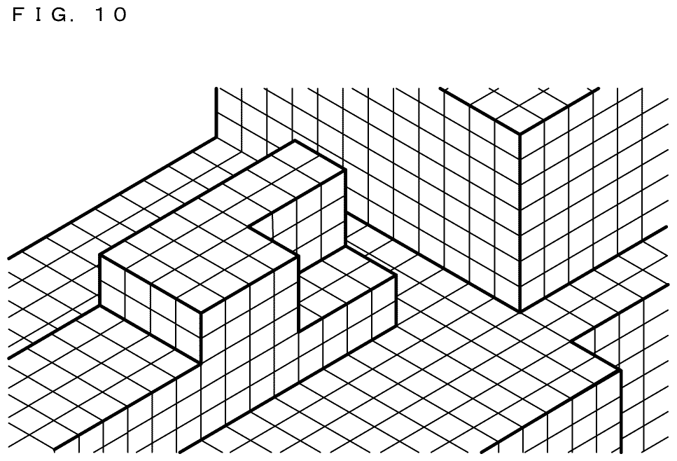

FIG. 11 is a diagram showing an example of content of voxel data. Here, in the present embodiment, the game space can be divided into a plurality of voxels arranged in a grid pattern. The game system 1 stores voxel data for each voxel in the game space so that the voxel data is associated with the voxel. The voxel data represents, for example, the presence/absence of a voxel object in the voxel corresponding to the voxel data.

As shown in FIG. 11, voxel data includes density data. The density data is data of a density indicating the degree to which an object is included in the region defined by each voxel. As will be described in detail below, the position and the shape of the surface of the voxel object (e.g., the mesh to be described below) are determined based on this density. In other words, in the present embodiment, this density is also data used to generate a mesh that defines the surface of the voxel object.

In the present embodiment, the density can take an integer value in the range from the lower limit value (e.g., 0) to the upper limit value (e.g., 255). In the present embodiment, in the game system 1, when the density value set for the voxel is high, the proportion of the volume to be occupied by the voxel object in the voxel is high. When the density value is low, the proportion is low. For example, if the density is 0, there is no object in the voxel, if the density is 255, the inside of the voxel is entirely the object, and if the density is between 0 and 255, the inside of the voxel is occupied by the object to the proportion that is determined based on the density value. Then, the shape of the voxel mesh, e.g., the shape of the voxel object, is determined based on the density. Note however that the shape of the voxel object generated based on the density does not need to have a volume that exactly matches the proportion represented by the density. For example, there is a case where the method of generating a voxel object as shown in FIG. 8 and the method of generating a voxel object as shown in FIG. 15 differ in volume, even if they are based on the same density.

In other embodiments, the density may indicate either a state in which the voxel object occupies the entirety of the region within the voxel or a state in which no voxel object is included in the region within the voxel. For example, the density data may be data that can take only either 0 or 1.

As shown in FIG. 11, voxel data includes material data. The material data represents the material (in other words, the substance) of the voxel object generated by the voxel data. Here, in the present embodiment, materials such as sand, rock and soil, for example, are set for voxel objects. That is, in the present embodiment, a plurality of types of materials are provided as materials that can be set for a voxel object, and one of the materials is set for a voxel object.

As shown in FIG. 11, in the present embodiment, the material data represents the identification information of the material (referred to as “material ID”). In the present embodiment, the game system 1 stores material information representing the property and the texture of the material for each material provided in the game. In the present embodiment, the material information represents associations between the material ID, the property of the material and the appearance (specifically, the texture) of the material. Specifically, the material information is information that represents associations between the material ID, identification information of the property of the material (referred to as “property ID”) and identification information of the texture of the material (referred to as “texture ID”) (see FIG. 11).

FIG. 12 is a diagram showing an example of property information representing properties of materials. As shown in FIG. 12, the game system 1 stores property information that associates each property ID with information that represents the content of the property represented by the property ID. A property of a material is a property of a voxel object for which the material is set in the game, and it may be information such as weight or slipperiness shown in FIG. 12, for example. Note that the specific content of the property is optional, and for example, the following information may be set as properties of a material.
Temperature
Breakability (e.g., the number of times of impact impartation needed to break a voxel object)
Whether another object can be bonded to a voxel object
Amount of hit points to be regained by the player character when the player character breaks a voxel object
Amount of in-game currency to be gained by the player character when the player character breaks a voxel object

Note that there is no limitation on the specific content of the property to be set for a material. In other embodiments, information different from those listed above may be set as information that represents a property of a material.

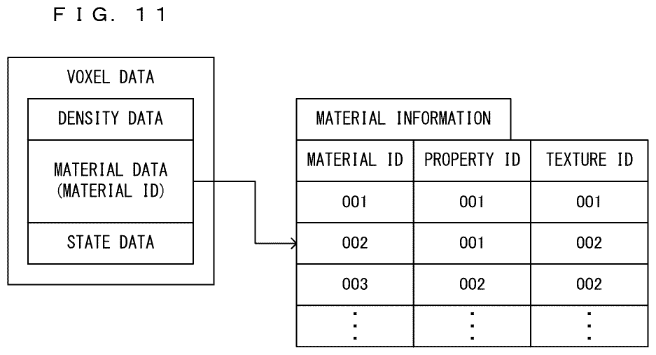

FIG. 13 is a diagram showing an example of texture information representing textures of materials. As shown in FIG. 13, the game system 1 stores texture information that associates the texture ID with the texture represented by the texture ID.

Note that in addition to information of texture, any information regarding the color and/or pattern may be set as data that defines the appearance of a voxel object. For example, a pattern of cracks may be set as information regarding the appearance of a voxel object. By using such a pattern, the game system 1 can generate an image of a voxel object that represents the appearance of cracks.

As described above, in the present embodiment, the material data defines, by the material ID, the property of the voxel object and the texture used for the voxel object. For example, when the material ID represented by the material data included in the voxel data is “002”, the property represented by the property ID “001” that is associated with the material ID in the material information is set as the property of the voxel object corresponding to the voxel data (see arrow shown in FIG. 11). In this case, the texture that is represented by the texture ID “002” associated with the material ID in the material information is applied to the voxel object corresponding to the voxel data (see arrow shown in FIG. 11).

As described above, in the present embodiment, the game system 1 separately manages the property and the texture of the material. Therefore, in the present embodiment, it is possible to easily set a plurality of types of materials having the same property but having different appearances (e.g., different textures) or set a plurality of types of materials having different properties but having the same appearance.

Note that the material data may be any data with which it is possible to identify the property and/or the texture of the material. For example, in other embodiments, the material data may represent the property ID and the texture ID, or may have a data structure that actually includes data representing the property and the texture of the material.

The material data may further represent information related to the material other than the property and the texture described above. For example, the material data may include special effect data that represents the special effect to be triggered upon satisfaction of a special effect triggering condition set for the voxel object (e.g., a portion of the voxel object being broken, or the character stepping on the voxel object). Note that the special effect data may be data that represents a special effect image (e.g., a special effect image showing the voxel object being broken), or may be data that represents a special effect sound (a sound of footstep when the character walks on the voxel object).

As shown in FIG. 11, the voxel data includes state data that represents the state of the voxel object. There is no limitation on the specific content of the state data. For example, the state data may be data that represents whether the voxel object is in a wet state, or may be data that represents the amount of damage applied to the voxel object. The content of the state data may be updated during the game.

### [2-2. Mesh]

In the present embodiment, the surface of the voxel object is represented by a mesh. A mesh is a set of faces (specifically, polygons) placed in the game space. In the present embodiment, the game system 1 generates a mesh for the voxel object based on the voxel data of each voxel set in the game space. An example of how a mesh is generated based on voxel data will now be described.

FIG. 14 is a diagram showing an example method for generating a mesh. Note that in FIG. 14, voxels and meshes are represented in two dimensions for the purpose of making the drawing easier to understand and for the sake of discussion, but in practice, a three-dimensional mesh is generated based on voxels in a three-dimensional space.

As described above, in the present embodiment, the density set for a voxel is in the range of 0 to 255. In the present embodiment, voxels with densities equal to or greater than the reference value are considered to be inside the voxel object, and voxels with densities less than the reference value are considered to be outside the voxel object. It is not necessary to define only voxels with a density of 0 as being outside the voxel object (e.g., reference value=1), and the reference value may be set to 128, for example. In the example shown in FIG. 14, a voxel 201 and the other outer voxels have a density of 0, a voxel 202 has a density of 100, which is less than the reference value (e.g., 128), and voxels 203 and 204 have densities of 150 and 200, which are greater than the reference value. In the present embodiment, the game system 1 generates vertices between those voxels whose densities are equal to or greater than the reference value and those voxels whose densities are less than the reference value. Specifically, for each region (region delimited by dotted lines) that straddles eight (four in the figure) adjacent voxels, it is determined whether or not to generate a vertex. That is, a vertex is generated in each region that straddles both a voxel whose density is equal to or greater than the reference value and a voxel whose density is less than the reference value. Then, a polygon mesh is generated by connecting together adjacent vertices if the connection (the boundary between the regions including the vertices) passes through a voxel whose density is equal to or greater than the reference value and a voxel whose density is less than the reference value. The coordinates of each vertex are determined by comparing densities of adjacent voxels and interpolating based on the difference in density for each of the XYZ axes. In this process, the coordinates can be further calculated based on the normal information. The normal information may be stored in advance for at least some of the voxels, or if not stored, the normal information may also be calculated based on densities between adjacent voxels. Note that in FIG. 14, the density of the voxel 202 is less than the reference value, the voxel 202 is treated as being outside the object in the determination of the presence/absence of a vertex, but the density value itself of the voxel 202 is used to calculate the coordinates of the vertices generated. If the reference value were set to a value lower than the density of the voxel 202, it would result in an increase in the vertices on the upper right side and the upper left side in the voxel 202 of FIG. 14.

By generating a polygon mesh as described above, it is possible to generate a shape whose volume is based on (e.g., reflects) the density of each voxel to some extent. Note however that depending on the relationship with neighboring voxels, it is possible that a voxel with a density of 0 may partially include a region inside the object, or a voxel with a density of 255 may partially include a region outside the object. Since voxels with densities less than the reference value are treated as being outside the object in the present embodiment, there are fewer vertices as compared with a case where those voxels are treated as being inside the object, the volume will be smaller accordingly. That is, there is no need to calculate the polygon mesh so that the volume strictly corresponds to the density value.

FIG. 15 shows an example of a game image including a terrain object. In the present embodiment, by generating a mesh as described above, the voxel object can be made in a shape with complicated irregularities compared to the cubic voxels, for example.

Note that there is no limitation on the method of generating a mesh based on voxel data. For example, in other embodiments, if the density of the voxel data is greater than a predetermined value, a mesh may be generated so that a cube is placed in the voxel corresponding to the voxel data (see FIG. 8).

For each face of the mesh generated as described above, the game system 1 determines the appearance (e.g., color and/or pattern) of each such face according to the material identified by the voxel data. Specifically, the game system 1 determines the texture to be used for rendering each face of the mesh based on the voxel data, and maps the determined texture to each face to generate an image of the voxel object. Note that the texture to be mapped to each face of the mesh is determined based on the voxel data of the voxel used to generate the face (which will be referred to as the target voxel) among the voxels where the voxel object exists. Note that the target voxel is, for example, one or more voxels located around the face, although it depends on the mesh generation method. That is, the texture mapped to a face of the mesh is determined to be a texture corresponding to the material set for one or more voxels placed around the face.

Note that in other embodiments, one voxel data may include multiple types (e.g., two types) of material data. In such a case, the voxel data includes ratio data related to the multiple types of material data. The ratio data is data for determining the texture to be used for the voxel object, and represents the ratio by which each of the materials (specifically, the texture corresponding to the material) represented by the multiple types of material data influences the appearance (specifically, the color and/or pattern) of the voxel object. When determining the texture to be mapped to each face of the mesh, the texture is determined based on various data (specifically, density data, multiple types of material data and ratio data) included in the voxel data of the target voxel. For example, when multiple types of materials are set for a target voxel corresponding to one face, a texture corresponding to the (one type of) material with the greatest degree of influence may be used while taking the ratio into consideration, or textures corresponding to multiple types of materials may be used while taking the ratio into consideration.

In other embodiments, there may be both voxel objects for which voxel data including one type of material data is used, and voxel objects for which voxel data including two types of material data is used.

### (Overview Of Game Processing)

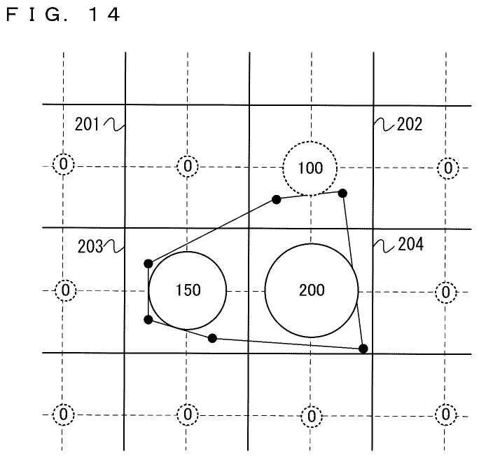

Next, a description is given of the destruction of a voxel object in a game according to the exemplary embodiment. FIG. 16 is a diagram showing an example of an image of a game space viewed from a virtual camera in a game according to the exemplary embodiment, and of a game image displayed on a display device. FIG. 17 is a diagram showing an example of the state where a destruction action is performed by a player character.

As shown in FIG. 16, in the game space, a player character PC is placed. In accordance with an operation of a player (e.g., an operation on the analog stick 32), the player character PC moves in the game space. In accordance with an operation of the player (e.g., an operation on the A-button 53 or the B-button 54), the player character PC performs various actions such as a punch and a jump in the game space. The player character PC is not a voxel object, and is a 3D object the shape of which is defined in advance by polygons.

If the game is started, a fixed voxel space defined by an Xs-Ys-Zs coordinate system is set as a voxel space representing a field in the game space. The axis directions of the Xs-Ys-Zs coordinate system are parallel to those of an XYZ coordinate system of the game space. That is, a Ys axis is an axis directed upward in the game space, and an Xs axis and a Zs axis are axes perpendicular to the Ys axis. Hereinafter, the voxel space defined by the Xs-Ys-Zs coordinate system will occasionally be referred to as a “field voxel space”. The position of each object present in the game space is represented by coordinate values in the Xs-Ys-Zs coordinate system. Although the direction of the Xs-Ys-Zs coordinate system representing the field voxel space match that of the XYZ coordinate system representing the game space here, these directions may not match each other.

In the field voxel space, terrain objects are set as voxel objects. For example, as the terrain objects, a terrain object 210 representing the ground and a terrain object 220 representing a rock pile are set. For example, material data indicating a rock is set in voxel data of each voxel located in a lower portion in the field voxel space, thereby forming the terrain object 210 representing the ground composed of rocks. Material data indicating a rock is set in pieces of voxel data of a plurality of voxels located above the ground in the field voxel space, thereby forming the terrain object 220 representing a rock pile raised from the ground.

The terrain object 210 representing the ground and the terrain object 220 representing a rock pile can be destroyed by a destruction action of the player character PC. Voxel data of a voxel in the field voxel space is updated, whereby the terrain objects 210 and 220 are destroyed.

For example, as shown in FIG. 17, in a case where the player character PC throws a punch as the destruction action, and if the punch hits the terrain object 220, a destruction range is set based on the position hit by the punch (the position of the player character PC). Then, the terrain object 220 included in the destruction range is destroyed and erased. Specifically, a destruction process for updating voxel data is performed on a voxel included in the destruction range, whereby the terrain object 220 included in the destruction range is erased.

The destruction range (an example of an erasure range) is a range set in an object hit by the destruction action of the player character PC, and set based on the position hit by the destruction action. For example, the destruction range is a range obtained by excluding from a predetermined shape a range below a predetermined surface set based on the position of the player character PC. The predetermined shape is a shape stored in advance and is a shape composed of a curved surface. In the exemplary embodiment, among a plurality of predetermined shapes, the predetermined shape is set in accordance with the direction of the destruction action. For example, if the player character PC performs the destruction action in the front direction, the predetermined shape is a first shape. The first shape may be, for example, a sphere, an ellipsoidal body, or a shape obtained by asymmetrically deforming an ellipsoidal body in the left-right direction (or the up-down direction). For example, the first shape when the player character PC throws a left punch may be an ellipsoidal body bulging to the left side and asymmetrical in the left-right direction. The first shape when the player character PC throws a right punch may be an ellipsoidal body bulging to the right side and asymmetrical in the left-right direction.

In the exemplary embodiment, if a punch thrown in the front direction of the player character PC hits an object, the first shape is set in front of the player character PC, and the first shape is corrected, whereby the destruction range is set. Specifically, a shape obtained by excluding from the first shape a range below a predetermined surface set based on the position of the player character PC is set as the destruction range.

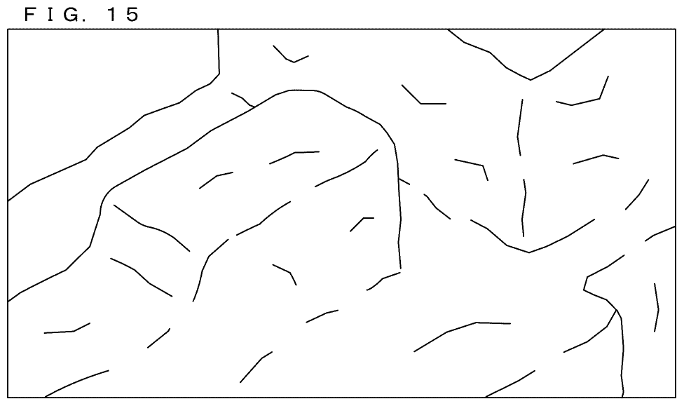

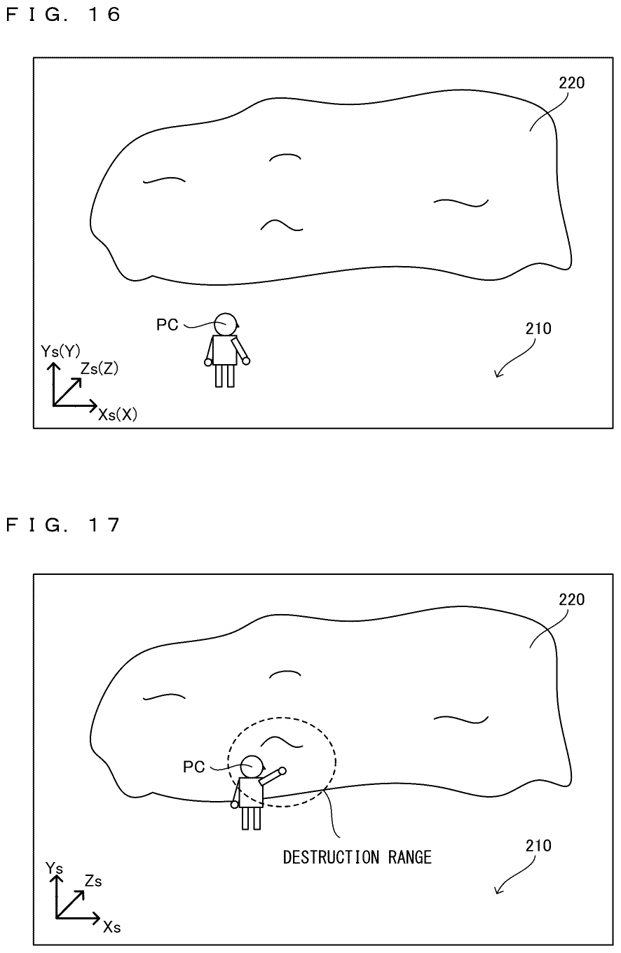

FIG. 18 is a diagram showing an example of the destruction range in a case where the first shape is not corrected and the terrain objects after the destruction in the destruction range. FIG. 19 is a diagram showing an example of the destruction range in a case where the first shape is corrected and the terrain objects after the destruction in the destruction range.

If a punch thrown in the front direction of the player character PC hits the terrain object 220, the destruction range having the first shape is set in front of the player character PC. For example, the destruction range having the first shape is set centered on a position in the field voxel space relating to the position of the first of (or near the first of) the player character PC in the game space. As shown in FIG. 18, if the destruction range is not corrected, the destruction range includes a part of the terrain object 220 representing a rock pile hit by the punch and a part of the terrain object 210 representing the ground. If a destruction process is performed on a voxel included in the destruction range, the terrain objects included in the destruction range are erased. In this case, the terrain after the destruction has a shape obtained by scraping a part of the terrain object 220 representing a rock pile and a part of the terrain object 210 representing the ground. If the first shape is not corrected as described above, the terrain after the destruction has a shape in which the periphery of the player character PC is recessed, and the ground after the destruction becomes uneven. In a case where the player character PC moves forward while destroying the terrain object 220 in front of the player character PC, and if the ground after the destruction becomes uneven, it may be difficult for the player character PC to move.

Accordingly, in the exemplary embodiment, the first shape is corrected so that the ground after the destruction is a flat surface. Specifically, as shown in FIG. 19, when a punch thrown in the front direction of the player character PC hits the terrain object 220, a predetermined surface (a flat surface) parallel to the ground is set at a position at the same height as that of the ground on which the player character PC is. Then, a shape obtained by excluding a part below the predetermined surface from the first shape is set as the destruction range. That is, if the predetermined surface at the same height as that of the ground is included in the first shape set based on the position of the player character PC, a shape obtained by excluding a part below the predetermined surface from the first shape is set as the destruction range so that the ground after the destruction is not uneven. In the example shown in FIG. 19, a range surrounded by a dashed line is set as the destruction range.

If the destruction range is set, a destruction process is performed on a voxel included in the destruction range. For example, regarding a voxel completely included in the destruction range, voxel data is rewritten with a value indicating that an object is not present. Specifically, regarding a voxel completely included in the destruction range, the density is set to “0”. Regarding a voxel partially included in the destruction range, the density of the voxel is set to the range from 128 to 254 (or 1 to 255), for example.

If a destruction process is performed on a voxel in the destruction range set (corrected) as described above, the terrain after the destruction is a curved surface by scraping a part of the terrain object 220 representing a rock pile, while the ground is a flat surface. As described above, it is possible to maintain the ground after the destruction as a flat surface, and it is possible to make it easy for the player character PC to move on the ground after the destruction.

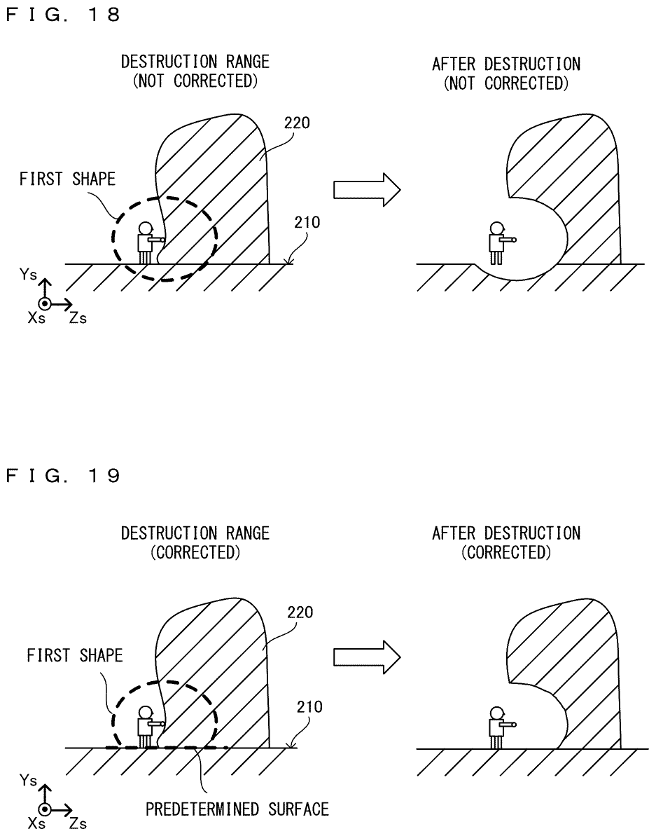

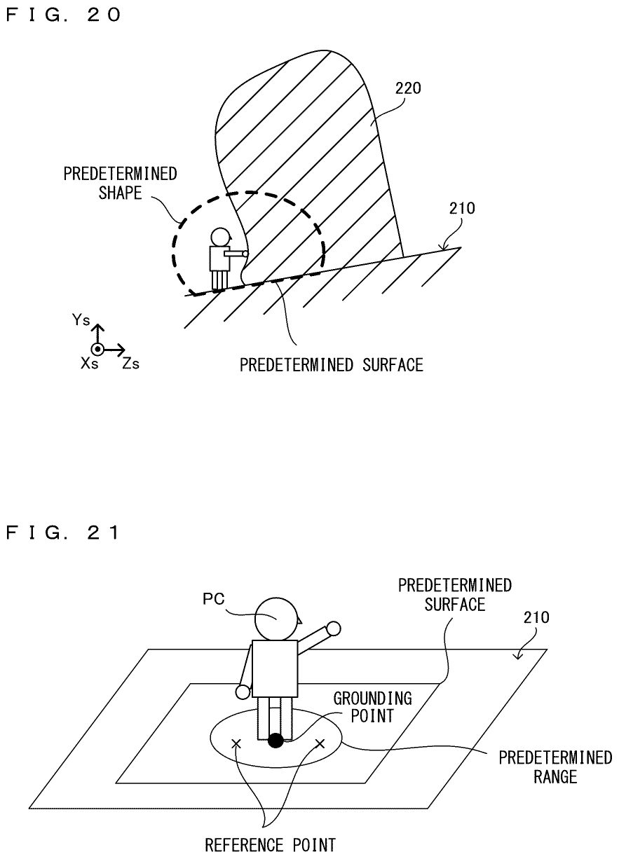

Here, when a punch thrown in the front direction of the player character PC hits the terrain object 220, and if the ground with which the player character PC is in contact is tilted to a horizontal plane, the predetermined surface is also tilted to the horizontal plane similarly to the ground. FIG. 20 is a diagram showing an example of the destruction range set when the player character PC throws a punch in the front direction in a case where the ground with which the player character PC is in contact is tilted.

As shown in FIG. 20, suppose that in a case where the ground with which the player character PC is in contact is tilted to the horizontal plane (an XZ plane), the player character PC throws a punch in the front direction, and the punch hits the terrain object 220. In this case, based on the position hit by the punch, the predetermined shape is set, and the predetermined surface having a tilt relating to the tilt of the ground with which the player character PC is in contact is also set. Specifically, the predetermined shape is set at a position obliquely above the player character PC. For example, the center of the predetermined shape may be set at a position in an obliquely upward direction along the ground from the position of the player character PC. The predetermined shape set at this time is the same shape as the first shape, and may be a shape obtained by tilting the first shape in accordance with the tilt of the ground. The predetermined shape may be a shape different from the first shape, and may be a shape relating to the tilt of the ground.

The predetermined surface is tilted similarly to the tilt of the ground with which the player character PC is in contact. For example, the game system 1 calculates the tilt of the ground with which the player character PC is in contact. Then, the game system 1 sets the predetermined surface having the tilt. The predetermined surface is set to pass through the position on the ground with which the player character PC is in contact (a grounding point). Then, a range obtained by excluding from the predetermined shape a part below the predetermined surface tilted in accordance with the tilt of the ground is set as the destruction range. Thus, the ground in the periphery of the player character PC after the destruction is tilted similarly to another portion of the ground. Consequently, in a case where the player character PC advances while throwing a punch in the front direction on a slope, it is possible to destroy a terrain while maintaining the slope.

Although a method for calculating the tilt of the ground (the tilt of the predetermined surface) is any method, for example, the tilt of the ground may be calculated based on normal vectors of reference points in a predetermined range including the position on the ground with which the player character PC is in contact (the grounding point).

FIG. 21 is a diagram showing an example of the calculation method for calculating the tilt of the ground with which the player character PC is in contact. As shown in FIG. 21, when a punch thrown in the front direction of the player character PC hits the terrain object 220, based on reference points in a predetermined range including the grounding point of the player character PC, the tilt of the ground may be calculated, and in accordance with the tilt of the ground, the predetermined surface may be set. For example, the average of normal vectors of a plurality of reference points is calculated, and a flat surface having a vector of the average as a normal vector is calculated as the predetermined surface. However, in a case where, based on the plurality of normal vectors, it is determined whether the periphery is somewhat flat or has an uneven shape, and if it is determined that the periphery is uneven, not a flat surface based on the average of the normal vectors, but a horizontal plane passing through the coordinates where the player character PC is in contact with the ground may be set as the predetermined surface. The predetermined surface is set to pass through a point (e.g., the grounding point) in the predetermined range.

Next, a description is given of a case where the player character PC throws a punch in the front direction when being in the air, and the punch hits the terrain object 220.

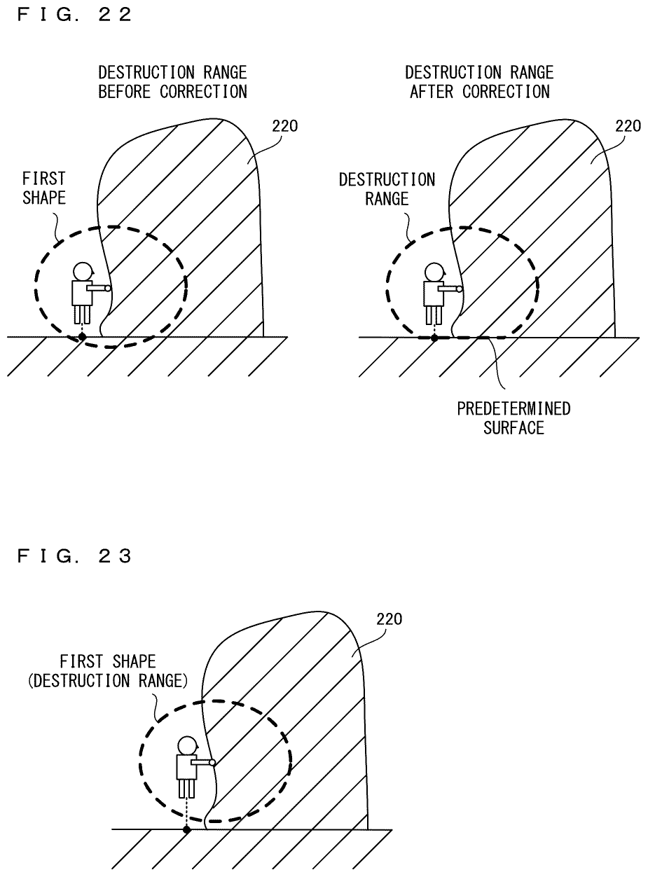

FIG. 22 is a diagram showing an example where the destruction range is corrected in a case where the player character PC throws a punch in the front direction when being in the air, and the punch hits the terrain object 220. FIG. 23 is a diagram showing an example where the destruction range is not corrected in a case where the player character PC throws a punch in the front direction when being in the air, and the punch hits the terrain object 220.

The player character PC may jump in the game space in accordance with an operation of the player and temporarily separate from the ground. Even when being in the air by the jump, the player character PC throws a punch in accordance with an operation input of the player. As shown in FIG. 22, when the player character PC is in the air, and in a case where a punch thrown in the front direction of the player character PC hits the terrain object 220, the predetermined surface is calculated based on the ground immediately below the player character PC. For example, if the punch of the player character PC hits the terrain object 220, based on reference points in the predetermined range including a position on the ground immediately below the player character PC at this time, a normal vector of the predetermined surface is calculated. The predetermined surface having the calculated normal vector and passing through a point in the predetermined range (e.g., an intersection point between a straight line extending immediately downward from the position of the player character PC and the ground) is set. Then, as shown in FIG. 22, if a part of the first shape set based on the position hit by the punch of the player character PC is located below the predetermined surface, a shape obtained by excluding the part below the predetermined surface from the first shape is set as the destruction range after correction. That is, if the predetermined surface is included in the first shape set based on the position hit by the punch of the player character PC, the destruction range is corrected.

Consequently, even if the player character PC is in the air, it is possible to correct the destruction range, and when the player character PC lands, it is possible to make it easy for the player character PC to move on the ground after the destruction.

On the other hand, as shown in FIG. 23, if the entirety of the first shape set based on the position hit by the punch of the player character PC is located above the predetermined surface, e.g., if the predetermined surface is not included in the first shape, the destruction range is not corrected, and the entirety of the first shape is set as the destruction range.

Consequently, if the predetermined surface is not included in the first shape, it is possible to destroy a terrain object with the first shape and make the shape after the destruction natural.

Next, a description is given of the correction of the destruction range in a case where the player character PC throws a punch in an obliquely upward direction.

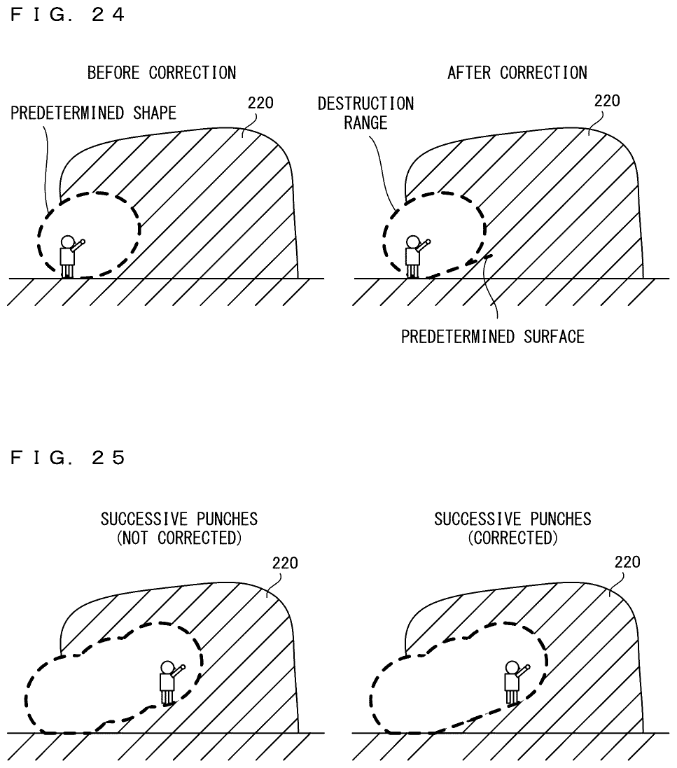

FIG. 24 is a diagram in which the destruction range before correction and the destruction range after the correction are compared with each other, and is a diagram showing an example of the destruction range in a case where the player character PC throws a punch in an obliquely upward direction.

If the player performs, for example, an operation for throwing a punch (e.g., pressing the A-button 53) while inputting the up direction (an obliquely upward direction) of the analog stick 32, the player character PC throws a punch in the obliquely upward direction. As shown in FIG. 24, if the punch in the obliquely upward direction of the player character PC hits the terrain object 220, the predetermined shape is set in the obliquely upward direction of the player character PC. For example, the center of the predetermined shape is set at a position in the field voxel space relating to the position of the first of the player character PC (a position in the obliquely upward direction of the player character PC) in the game space. The predetermined shape set when the punch in the obliquely upward direction hits the terrain object 220 is a second shape different from the first shape set when the punch in the front direction hits the terrain object 220. For example, the second shape set when the punch in the obliquely upward direction hits the terrain object 220 may be a symmetrical ellipsoidal body or a sphere. The predetermined shape set when the punch in the obliquely upward direction hits the terrain object 220 may be the same as the first shape set when the punch in the front direction hits the terrain object 220.

As shown in the right diagram of FIG. 24, if the punch in the obliquely upward direction is thrown, the predetermined surface is set to be tilted in the obliquely upward direction. For example, the predetermined surface is set to have a predetermined angle to a horizontal plane. However, in a case where the player character PC throws a punch in the obliquely upward direction, and if the ground on which the player character PC is further tilted than the above predetermined angle, the predetermined surface may be set with the tilt relating to the tilt of the ground.

FIG. 25 is a diagram in which a case where the destruction range is not corrected and a case where the destruction range is corrected are compared with each other, and is a diagram showing an example of the terrain after the destruction in a case where the player character PC throws successive punches in the obliquely upward direction.

As shown in the left diagram in FIG. 25, in a case where the destruction range is not corrected, and if the player character PC moves forward while throwing successive punches in the obliquely upward direction, the ground after the destruction becomes uneven. On the other hand, as shown in the right diagram in FIG. 25, if the destruction range is corrected, the ground after the destruction is a slope without unevenness.

As described above, if the punches in the obliquely upward direction are thrown, the second shape is set obliquely above the player character PC, and the predetermined surface is also set to become higher in the forward direction of the player character PC. Then, a shape obtained by excluding a part below the predetermined surface from the second shape is set as the destruction range. Consequently, if the player character PC throws punches in the obliquely upward direction, the ground after the destruction is a slope rising in the forward direction of the player character PC. Thus, it is possible to form the ground after the destruction along the destruction direction and the moving direction of the player character PC.

Next, a description is given of the destruction range in a case where the player character PC throws a punch in the down direction.

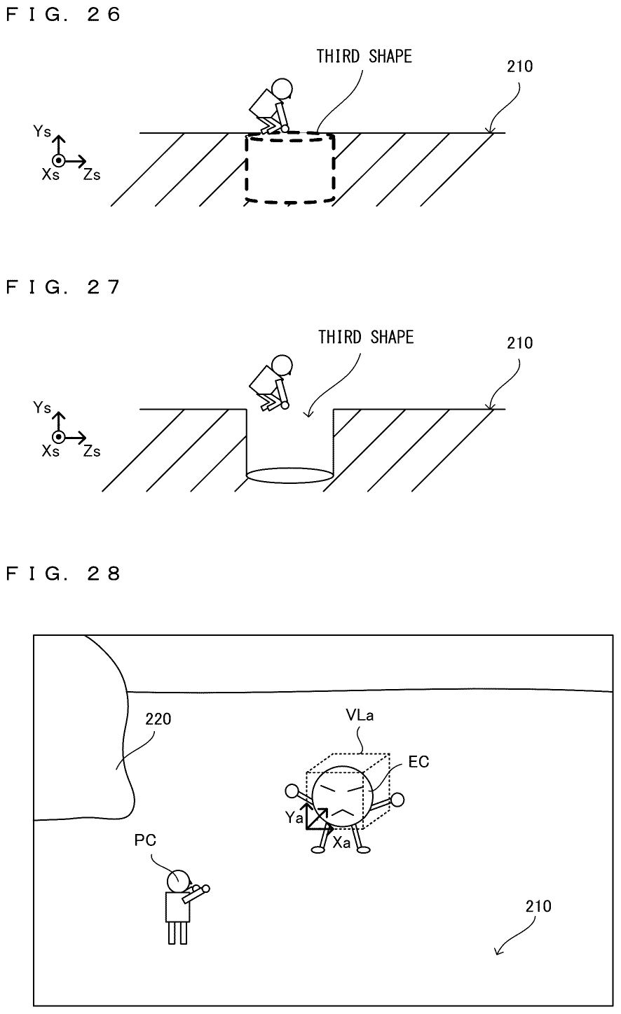

FIG. 26 is a diagram showing an example of the destruction range set in a case where the player character PC throws a punch in the down direction. FIG. 27 is a diagram showing an example of the terrain after a terrain object is destroyed in the destruction range set in a case where the player character PC throws the punch in the down direction.

If the player performs, for example, an operation for throwing a punch while inputting the down direction of the analog stick 32, the player character PC throws a punch in the down direction. As shown in FIG. 26, if the player character PC throws a punch in the down direction, the punch hits the terrain object 210 representing the ground existing in the down direction of the player character PC. In this case, the destruction range having a third shape is set based on the position hit by the punch. The third shape is a shape different from the first shape and the second shape, and for example, is a cylindrical shape. The bottom surface of the third shape is a flat surface. The set third shape is not corrected as described above. If a destruction process is performed on a voxel included in the destruction range having the set third shape, a voxel object in the destruction range is erased. Consequently, as shown in FIG. 27, a hole having the third shape is formed in the ground. The bottom of the hole is a flat surface. Further, if the player character PC throws a punch in the down direction at the bottom of the hole, a hole having the third shape is further formed.

As described above, if the third shape of which the bottom surface is a flat surface is set in advance, and a punch in the down direction is thrown, the third shape is set as the destruction range. Consequently, without making the above correction, it is possible to cause the shape of the ground after the destruction to be a flat surface, and it is possible to make it easy for the player character PC to move on the ground after the destruction.

In the exemplary embodiment, the direction of the destruction action of the player character PC is any of the front direction (a direction parallel to a horizontal plane), the obliquely upward direction, and the down direction (a direction perpendicular to the horizontal plane). In another exemplary embodiment, however, the direction of the destruction action of the player character PC is not limited to these directions. For example, the player character PC may be able to throw a punch in an obliquely down direction. In this case, if the punch in the obliquely down direction hits a terrain object, the first shape or the second shape may be set in the obliquely down direction of the player character PC. The predetermined surface is a slope obtained by tilting a flat surface and is set to fall in the forward direction of the player character PC. Then, a shape obtained by excluding a range below the predetermined surface from the first shape or the second shape may be set as the destruction range.

In the exemplary embodiment, in the game space, in addition to the above terrain objects defined by voxels in the field voxel space, another voxel object is placed. FIG. 28 is a diagram showing an example of a voxel object other than the terrain objects 210 and 220 placed in the game space.

As shown in FIG. 28, in the game space, an enemy object EC is placed. The enemy object EC is a character automatically controlled by the processor 81 and moves in the game space, changes its orientation, or attacks the player character PC.

The enemy object EC is a voxel object, and the shape of the enemy object EC is prescribed by pieces of voxel data of a plurality of voxels in a voxel space VLa. The voxel space VLa is a voxel space placed in the game space and different from the field voxel space and is defined by an Xa-Ya-Za coordinate system. In the pieces of voxel data of the plurality of voxels in the voxel space VLa, the value of a density indicating that an object is present and material data indicating an enemy object are set. Consequently, the enemy object EC is formed. As described above, a polygon mesh is generated and drawn based on voxel data of each voxel, whereby the enemy object EC is displayed. Although the torso of the enemy object EC is a voxel object, hand and foot portions of the enemy object EC may not be a voxel object, and may be a 3D object the shape of which is defined in advance by polygons.

In FIG. 28, the voxel space VLa is indicated by a dotted line for illustrative purposes, but actually, the dotted line indicating the voxel space VLa is not displayed during the game.

A single voxel in the field voxel space is a cube area a side of which has a predetermined length. Here, in the game space, a length is defined, and for example, “m (meter)” is used as a length unit. For example, the height of the player character PC in the game space may be defined as 2 m. The length of a side of a single voxel in the field voxel space is, for example, “1 m”. On the other hand, the length of a side of a single voxel in the voxel space VLa is “0.5 m”, for example.

Also if the destruction action of the player character PC is performed on the enemy object EC, the destruction range is set by a method similar to the above. For example, if a punch thrown in the front direction of the player character PC hits the enemy object EC, the first shape is set at a position in the voxel space VLa relating to the position hit by the punch (the position of the player character PC) in the game space. The size in the game space of the first shape set here is smaller than the size in the game space of the first shape set when the punch thrown in the front direction of the player character PC hits a terrain object. For example, when the punch thrown in the front direction of the player character PC hits a terrain object, the first shape having a first size is set. When the punch thrown in the front direction of the player character PC hits the enemy object EC, the first shape having a second size is set. Also if the punch thrown in the front direction of the player character PC hits the enemy object EC, the destruction range is corrected similarly to a case where the punch hits a terrain object. Specifically, the predetermined surface is set as described above, and a shape obtained by excluding a part below the predetermined surface from the first shape is set as the destruction range. If the punch in the front direction hits the enemy object EC, the destruction range is relatively small, and therefore, it is possible to gradually destroy the enemy object EC in a small range. If, on the other hand, the punch in the front direction hits the terrain object 220, the destruction range is relatively great, and therefore, it is possible to destroy the terrain object 220 in a large scale by a single destruction action.

In addition to the enemy object EC, yet another voxel object may be placed in the game space. In this case, a voxel space different from the field voxel space may be set. For example, a terrain object included in the destruction range set as described above may be destroyed, and a part of the terrain object may separate by the destruction, and a debris object as the debris of the terrain object may be generated. In this case, a voxel space different from the field voxel space is newly generated. The position and the orientation in the game space of the newly generated voxel space may be changed, whereby the debris object may move in the game space or may change its orientation. If, for example, the destruction action in the front direction is performed on such a voxel object, the first shape is set in the voxel space relating to the voxel object, and the predetermined surface is also set. Then, a shape obtained by excluding a part below the predetermined surface from the first shape is set as the destruction range.

In the exemplary embodiment, if the destruction action hits a voxel object, it is not that the destruction process (the update of the density) is always performed on a voxel included in the destruction range set (corrected) as described above. The density of the voxel included in the destruction range is updated in accordance with the “fragility” of a material (a substance) in the material data set in the voxel. Specifically, the density of the voxel included in the destruction range may or may not be updated in accordance with “the hardness of the destroying side”, “the hardness of the destruction target side”, and the “amount of damage” of the voxel.

More specifically, “the hardness of the destroying side” is set in the range from 1 to 5 in accordance with the type of the destruction action. “The hardness of the destruction target side” has a value relating to a material indicated by voxel data and is set in the range from 1 to 5, for example. If “the hardness of the destroying side” and “the hardness of the destruction target side” satisfy a predetermined condition, the amount of damage of a voxel included in the set (corrected) destruction range as described above is decreased. If the amount of damage of the voxel reaches an endurance value set in advance, the density of the voxel is updated. That is, the density of the voxel in the destruction range set as described above is updated to a value indicating that an object is not present. Consequently, the voxel object in the destruction range is destroyed. If, on the other hand, the amount of damage of the voxel included in the set (corrected) destruction range as described above does not reach the endurance value, the density of the voxel is not updated. That is, the voxel object is not destroyed. In this case, when the amount of damage of the voxel in the set (corrected) destruction range reaches the endurance value due to the destruction action performed multiple times, the density of the voxel in the destruction range is updated, and the voxel object is destroyed.

If, on the other hand, “the hardness of the destroying side” and “the hardness of the destruction target side” satisfy another condition, the amount of damage of the voxel in the set (corrected) destruction range is not decreased, and the density of the voxel in the destruction range is updated. In this case, the density of the voxel in the destruction range is updated by the destruction action performed once, and the voxel object is destroyed.

As described above, in the exemplary embodiment, in a case where the player character PC throws a punch in the front direction when being on the ground, and if the punch hits a terrain object, a range that is set in accordance with the position of the player character PC and has a shape obtained by excluding a part below the predetermined surface from the first shape is set as the destruction range. The first shape is a shape set in advance based on the destruction action of the player character PC. The predetermined surface is a surface set based on the position of the player character PC. Specifically, the predetermined surface is a flat surface that is parallel to the ground with which the player character PC is in contact, and has the same height as that of the ground. The destruction range is set as described above, and the voxel object in the destruction range is destroyed (erased), whereby it is possible to cause the ground after the destruction to be a flat surface, and it is possible to make it easy for the player character PC to move.

In a case where the player character PC throws a punch in the front direction when being in the air, and if the punch hits a terrain object, the predetermined surface is set based on the ground located below (specifically, immediately below) the player character PC. Then, if a part of the first shape is below the predetermined surface, a shape obtained by excluding the part below the predetermined surface from the first shape is set as the destruction range. Consequently, even if the terrain object is destroyed when the player character PC is in the air, it is possible to cause the ground after the destruction to be a flat surface, and it is possible to make it easy for the player character PC to move. If, on the other hand, the entirety of the first shape is above the predetermined surface, the first shape is set as the destruction range. Consequently, if the movement of the player character PC is not influenced after the destruction, it is possible to destroy the terrain object in the range of the first shape, and for example, it is possible to cause the terrain after the destruction to have a natural shape.

If a punch in the obliquely upward direction of the player character PC hits a terrain object when the player character PC is on the ground, the predetermined surface tilted to a horizontal plane is set. Specifically, the predetermined surface is a slope in which the further in the forward direction of the player character PC the slope is, the higher the slope is. Then, a shape obtained by excluding a part below the predetermined surface from the predetermined shape is set as the destruction range. Consequently, if the player character PC throws a punch in the obliquely upward direction, it is possible to cause the ground after the destruction to be a slope without unevenness, and it is possible to destroy a terrain object along the direction of the destruction action and the moving direction of the player character PC.

When the player character PC is on the tilted ground, and if the destruction action of the player character PC hits a terrain object, the predetermined surface is also tilted similarly to the ground. Consequently, it is possible to cause the ground in the periphery of the player character PC after the destruction to be a slope similarly to the ground in another portion, and it is possible to destroy a terrain object along the ground on which the player character PC is.

In the exemplary embodiment, also if the destruction action is performed on a voxel object that is different from a terrain object defined in the field voxel space and is an object (e.g., the enemy object EC) formed of a voxel in a second voxel space (e.g., the voxel space VLa) different from the field voxel space, the destruction range is set by a method similar to the above.

In a case where the destruction action is performed on the enemy object EC, the destruction range is set to be smaller than in a case where the destruction action is performed on a terrain object. Consequently, it is possible to gradually destroy the enemy object EC in a small range, while it is possible to destroy the terrain object in a large scale.

The size of a single voxel in the voxel space VLa for forming the enemy object EC is smaller than that of a single voxel in the field voxel space for forming a terrain object. Consequently, it is possible to finely represent the enemy object EC and also finely destroy the enemy object EC.

### [3. Specific Example of Processing by Game System]

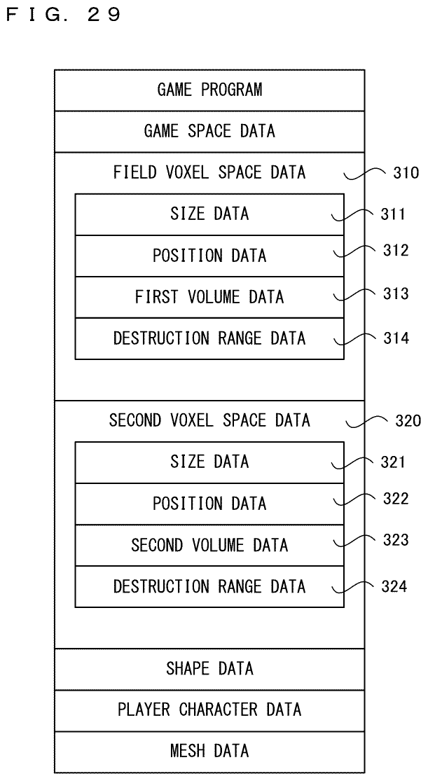

Next, with reference to FIGS. 29 to 31, a specific example of information processing by the game system 1 is described.

FIG. 29 is a diagram showing examples of various pieces of data used in the information processing by the game system 1. As shown in FIG. 29, the game system 1 stores a game program, game space data, field voxel space data 310, second voxel space data 320, shape data, player character data, and mesh data.

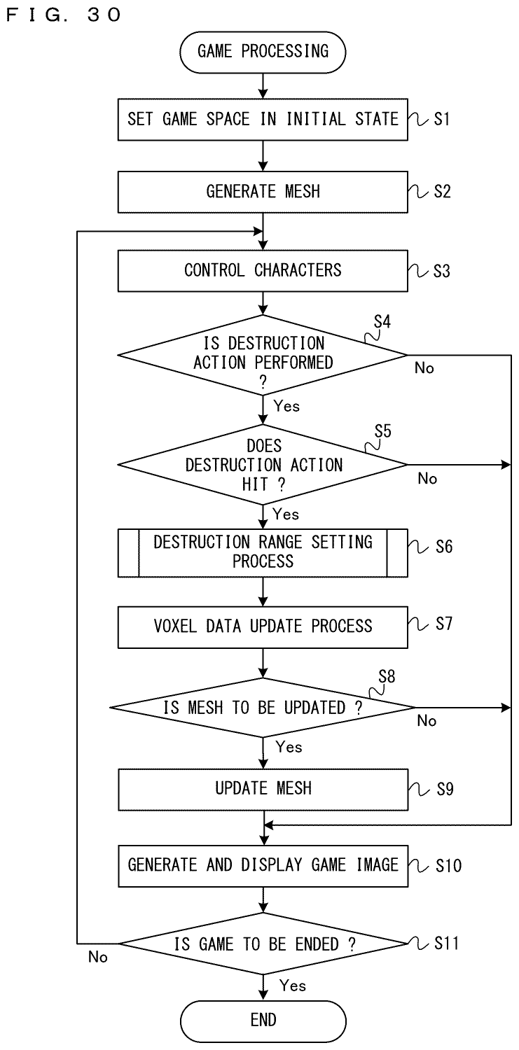

The game program is a program for executing game processing according to the exemplary embodiment (specifically, game processing shown in FIG. 30). The game program is stored in advance in a storage medium attached to the slot 23 or the flash memory 84 and is loaded into the DRAM 85 when the game is executed.

The game space data is data for defining the game space and includes data indicating the above XYZ coordinate system.

The field voxel space data 310 is data regarding the entirety of the field voxel space. As shown in FIG. 29, the field voxel space data 310 includes size data 311. The size data 311 indicates the length of a side of each voxel in the field voxel space. For example, the length of a side of each voxel in the field voxel space is 1 m. The field voxel space data 310 also includes position data 312. The position data 312 is data indicating the position and the rotation of the field voxel space in the game space. In the exemplary embodiment, the field voxel space is fixed to the game space.

The field voxel space data 310 also includes first volume data 313. The first volume data 313 includes voxel data of each voxel in the field voxel space. Voxel data is set for each voxel, and a mesh is generated based on the voxel data, whereby a terrain is formed in the game space. In the storage medium attached to the slot 23 or the flash memory 84, the first initial field volume data 313 is stored in advance. When the game starts, the first volume data 313 stored in the storage medium attached to the slot 23 or the flash memory 84 is loaded into the DRAM 85. Consequently, initial terrains are formed. For example, as the initial terrains, the terrain object 210 representing a horizontal ground and the terrain object 220 representing a rock pile are formed. Each piece of voxel data included in the first volume data 313 stored in the DRAM 85 is changed during the execution of the game, whereby the terrains are changed.

The field voxel space data 310 includes destruction range data 314. The destruction range data 314 is data indicating a destruction range set in a case where the destruction action performed by the player character PC hits a terrain object formed based on the first volume data 313.

The second voxel space data 320 is data regarding the above voxel space VLa placed in the game space. The second voxel space data 320 includes size data 321, position data 322, second volume data 323, and destruction range data 324. The size data 321 includes data indicating the length of a side of each voxel in the voxel space VLa and data indicating the number of voxels in the directions of the axes (the Xa, Ya, and Za axes) of the voxel space VLa. For example, the length of a side of each voxel in the voxel space VLa is “0.5 m”. The size of the voxel space VLa in the game space is determined based on the size data 321. The position data 322 is data indicating the position and the rotation of the voxel space VLa in the game space. For example, the position data 322 includes coordinate data indicating a position in the game space and vector data indicating the directions of the axes (the Xa, Ya, and Za axes) of the voxel space VLa in the game space. The position data 322 is changed, whereby the position and/or the orientation of the voxel space VLa (e.g., the enemy object EC) in the game space are changed.

The second volume data 323 is data for representing the enemy object EC. With respect to each voxel included in the voxel space VLa, the second volume data 323 holds voxel data indicating the presence of an object. That is, the second volume data 323 includes voxel data of each voxel included in the voxel space VLa. Voxel data is set for each voxel in the voxel space VLa, and a mesh is generated based on the voxel data, whereby the enemy object EC is formed.

The destruction range data 324 is data indicating a destruction range set in a case where the destruction action performed by the player character PC hits the enemy object EC formed based on the second volume data 323.

The shape data is data indicating the above predetermined shape and includes data indicating the above first shape set in advance, data indicating the above second shape set in advance, and data indicating the above third shape set in advance. The player character data is data regarding the player character PC and includes data indicating the position and the orientation in the game space of the player character PC.

The mesh data is data indicating a mesh set for a voxel object placed in the game space. The mesh data includes, for example, data indicating the position of each vertex in the mesh. The mesh data is generated based on the first volume data 313, the second volume data 323, and the like.

The game system 1 stores data of the above property information and texture information, data regarding various characters that appear in the game, and the like as data stored in advance before the execution of the game processing in addition to the data shown in FIG. 29. The game system 1 also stores 3D object data indicating a 3D object different from a voxel object (e.g., the player character PC and parts such as the hands and feet of the enemy object EC). Voxel space data is stored with respect to each voxel object capable of moving in the game space.

FIG. 30 is a flow chart showing an example of the flow of the game processing executed by the game system 1. The game processing shown in FIG. 30 is started in accordance with, for example, an instruction to start the game given by the player.

In the exemplary embodiment, the description is given on the assumption that the processes of steps shown in FIG. 30 are executed by the processor 81 of the main body apparatus 2 executing the game program stored in the game system 1. In another exemplary embodiment, however, some of the processes of the above steps may be executed by a processor (e.g., a dedicated circuit or the like) different from the processor 81. Further, in a case where the game system 1 can communicate with another information processing apparatus (e.g., a server), some of the processes of the steps shown in FIG. 30 may be executed by the other information processing apparatus. The processes of all of the steps shown in FIG. 30 are merely illustrative. Thus, the processing order of the steps may be changed, or another process may be performed in addition to (or instead of) the processes of all of the steps, so long as similar results are obtained.

The processor 81 executes the processes of steps shown in FIG. 30 using a memory (e.g., the DRAM 85). That is, the processor 81 stores information (in other words, data) obtained in the processing steps in the memory, and if the information is used in the subsequent processing steps, reads the information from the memory and uses the information.

As shown in FIG. 30, in step S1, the processor 81 sets the game space in an initial state. Specifically, the processor 81 acquires the first volume data 313 indicating the terrains in the game space in the initial state from the storage medium attached to the slot 23 and stores a part or all of the acquired first volume data 313 in the DRAM 85. The processor 81 also reads the second volume data 323, the shape data, and the like from the above storage medium and stores the read data in the DRAM 85. The processor 81 also reads 3D object data from the above storage medium, sets the initial position and the orientation of a 3D object, and stores the initial position and the orientation in the DRAM 85. The processor 81 also sets the initial position and the orientation of the virtual camera and stores the initial position and the orientation in the DRAM 85.

The voxel data to be written to the DRAM 85 may be voxel data of a partial range used to generate a game image in voxel data of the entire range of the game space. The processor 81 may generate an image of an object using, for example, pieces of voxel data of voxels included in a partial range (e.g., a range within a predetermined distance from the position of the virtual camera) of the game space. If voxel data regarding the partial range of the game space is written, a process similar to that of the above step S1 is executed at an appropriate timing during the execution of the series of processes of steps S2 to S11 (e.g., the timing when the position of the virtual camera moves by a predetermined distance or more).

In step S2, the processor 81 generates a mesh regarding each voxel object. The mesh is generated in accordance with the method described in the above “[2-2. Mesh]”. Specifically, based on the pieces of volume data stored in the DRAM 85 in step S1, the processor 81 generates a mesh representing each voxel object. Consequently, a terrain object is constructed in the game space, and the enemy object EC is also placed in the game space. For example, based on a plurality of pieces of voxel data included in the first volume data 313, the processor 81 generates a polygon mesh between a voxel for which a value indicating that an object is present is set and a voxel for which a value indicating that an object is not present is set. An example of a specific method for determining the vertex positions is as described above with reference to FIG. 14. Based on a plurality of pieces of voxel data included in the second volume data 323, the processor 81 also generates a polygon mesh between a voxel for which a value indicating that an object is present is set and a voxel for which a value indicating that an object is not present is set. Consequently, a polygon mesh representing the enemy object EC is generated. After step S2, the game is started, and the processes of steps S3 to S11 are repeatedly executed at predetermined frame time intervals (e.g., 1/60-second intervals) during the game.

In step S3, the processor 81 controls the actions of various objects (e.g., the player character PC and the enemy object EC) that appear in the game space. For example, based on operation data received from the controllers 3 and 4, the processor 81 moves the player character PC and causes the player character PC to perform a predetermined action (the destruction action, a jump, or the like). The destruction action of the player character PC may be a punch, a kick, the throwing of a bullet, or the like. Based on an algorithm determined in the game program, the processor 81 moves the enemy object EC and causes the enemy object EC to perform the destruction action (the swinging or throwing of a weapon object or the like). After step S3, the process of step S4 is executed.

In step S4, based on operation data from the controllers, the processor 81 determines whether or not the destruction action is performed by the player character PC. Specifically, based on the operation data from the controllers, it is determined whether or not a predetermined button of the left controller 3 or the right controller 4 is pressed. If the result of the determination in step S4 is affirmative, the process of step S5 is executed. If, on the other hand, the result of the determination in step S4 is negative, the process of step S10 is executed.

In step S5, the processor 81 determines whether or not the destruction action hits a voxel object. Here, for example, it is determined whether or not the destruction action of the player character PC hits a terrain object or the enemy object EC. The terrain object is the terrain object 210 representing the ground, the terrain object 220 representing a rock pile, or the like. The determination of whether or not the destruction action hits the voxel object is made by a physical determination between the object on the destroying side and the voxel object on the destruction target side. For example, in a case where the player character PC throws a punch, the object on the destroying side is the first of the player character PC. The voxel object on the destruction target side is the terrain object or the enemy object EC, and a determination mesh is generated. The determination mesh may be the same as a display mesh, or a determination mesh coarser than the display mesh may be prepared. A collision determination is made between the determination mesh and the object on the destroying side, and it is determined whether or not the determination mesh and the object on the destroying side hit each other. If the result of the determination in step S5 is affirmative, the process of step S6 is executed. If, on the other hand, the result of the determination in step S5 is negative, the process of step S10 is executed.

In step S6, the processor 81 performs a destruction range setting process for setting a destruction range in accordance with the voxel object hit by the destruction action. The details of the destruction range setting process will be described below. After step S6, the process of step S7 is executed.

In step S7, the processor 81 executes a voxel data update process. For example, the processor 81 decreases the density of a voxel included in the destruction range set in step S6. Specifically, based on “the hardness of the destroying side” relating to the destruction action and “the hardness of the destruction target side” relating to the material of the voxel object hit by the destruction action, it is determined whether to update the amount of damage of the voxel included in the destruction range or update the density without updating the amount of damage. If it is determined that the amount of damage is to be updated, the amount of damage of the voxel included in the destruction range set in step S6 is updated. If the updated amount of damage exceeds an endurance value relating to the material, the density of the voxel included in the set destruction range is decreased. If it is determined that the density is to be updated without updating the amount of damage, the density of the voxel included in the set destruction range is decreased. Specifically, the density of the voxel included in the set destruction range is set to a value indicating that an object is not present (e.g., “0”). After the process of step S7, the processor 81 executes the process of step S8.

In step S8, the processor 81 determines whether or not a mesh is to be updated. Here, if voxel data is updated in step S7, the processor 81 determines that a mesh is to be updated. If the result of the determination in step S8 is affirmative, the process of step S9 is executed. If, on the other hand, the result of the determination in step S8 is negative, the process of step S10 is executed. Even if voxel data is updated in step S7, but if an updated voxel is not present in the image capturing range of the virtual camera, the processor 81 may determine in step S8 that a mesh is not to be updated. That is, even if the destruction action hits a terrain object or the enemy object EC and a part or the entirety of the terrain object or the enemy object EC is destroyed, but if a voxel object in the game space that can be viewed from the virtual camera is not destroyed, a mesh may not be updated. When the processing load is high, the update of the mesh may not be performed in this frame, and may be carried over to the next frame and subsequent frames.

In step S9, the processor 81 updates a mesh regarding a voxel object of which voxel data is changed in step S7. Specifically, based on the updated voxel data, the vertex positions of the mesh are recalculated. The updated mesh is stored as mesh data in the DRAM 85. That is, based on the voxel data updated in step S7, the processor 81 generates the mesh of the destroyed voxel object. Consequently, during the game, it is possible to dynamically change the mesh of a voxel object (the terrain object or the enemy object EC) on which the destruction action is performed. In step S9, the vertices of the mesh of only a portion where the voxel data is updated are recalculated. Regarding the mesh of a portion where the voxel data is not updated, the vertex positions of the mesh generated in step S2 are used. As described above, the mesh is recalculated only regarding the updated voxel data, and therefore, it is possible to decrease the processing load. In another exemplary embodiment, in step S9, based on all the pieces of voxel data in the game space (or all the pieces of voxel data in the image capturing range of the virtual camera) including both voxel data that is updated and voxel data that is not updated, the vertex positions of the mesh may be recalculated. After step S9, the process of step S10 is executed.

In step S10, the processor 81 generates a game image representing the game space based on the virtual camera and displays the generated game image on the display device. Specifically, the processor 81 generates a game image of the mesh generated in step S2 or S9 when viewed from the position of the virtual camera. Consequently, a game image representing the game space including a voxel object and another 3D object (e.g., the player character PC) is generated. Then, the processor 81 displays the generated game image on the display device. After step S10, the process of step S11 is executed.

In step S11, the processor 81 determines whether or not the game is to be ended. For example, the processor 81 determines whether or not an instruction to end the game is given by the user. If the result of the determination in step S11 is negative, the process of step S3 is executed again. From this point onward, the series of processes of steps S3 to S11 are repeatedly executed until it is determined in step S11 that the game is to be ended. If, on the other hand, the result of the determination in step S11 is affirmative, the processor 81 ends the game processing shown in FIG. 30.

### (Destruction Range Setting Process)

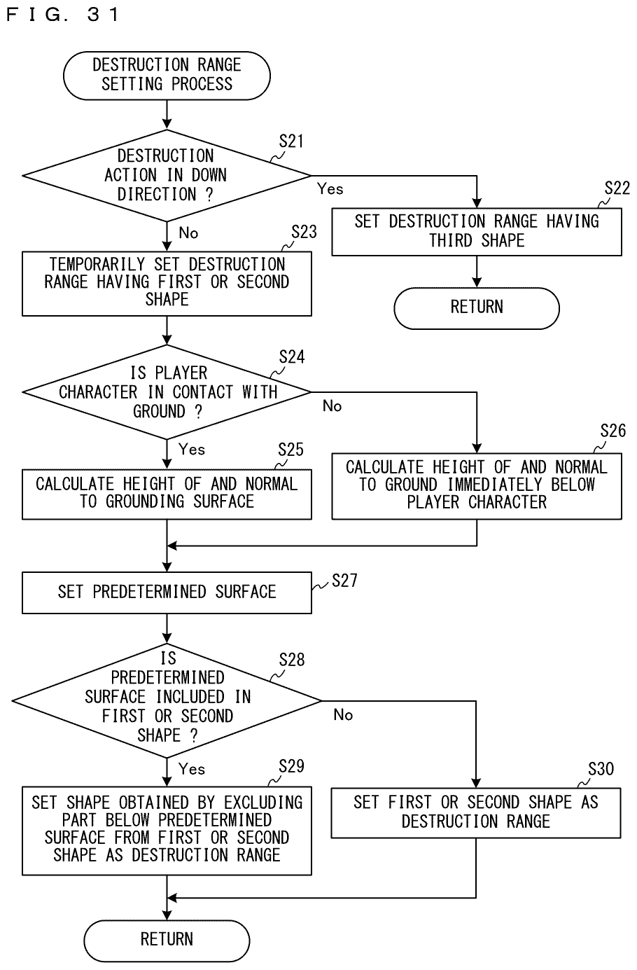

The destruction range setting process in step S6 is described below. FIG. 31 is a flow chart showing an example of the destruction range setting process in step S6.

In step S21, the processor 81 determines whether or not the destruction action in the down direction is performed. If the result of the determination in step S21 is affirmative, next, the process of step S22 is executed. If, on the other hand, the result of the determination in step S21 is negative, next, the process of step S23 is executed.

In step S22, the processor 81 sets the destruction range having the third shape. Specifically, the destruction range having the third shape is set in the voxel space relating to the object hit by the destruction action. For example, if the destruction action hits the terrain object 210, the destruction range having the third shape is set in the field voxel space based on the position hit by the destruction action (e.g., the position of the first of the player character PC). The third shape is a shape of which the bottom surface is a flat surface, and for example, is a cylindrical shape. Here, the size of the destruction range differs in accordance with the object hit by the destruction action. For example, if the destruction action hits the terrain object (210 or 220), the destruction range having the first size is set, and the destruction range data 314 indicating the destruction range is stored. For example, if the destruction action hits the enemy object EC, the destruction range having the second size smaller than the first size is set, and the destruction range data 324 indicating the destruction range is stored. The third shape may be an approximately cylindrical shape and a shape in which a connection portion between the bottom surface and the side surface is a curved surface. If the process of step S22 is performed, the processor 81 ends the process shown in FIG. 31.

On the other hand, in step S23, the processor 81 temporarily sets the destruction range having the first shape or the second shape in accordance with the direction of the destruction action. Specifically, the destruction range having the first shape or the second shape is temporarily set in the voxel space relating to the object hit by the destruction action. The destruction range having the first shape or the second shape is temporarily set at a position relating to the direction of the destruction action. For example, if the destruction action in the front direction of the player character PC hits the terrain object 220, the destruction range having the first shape is temporarily set at a position in the field voxel space. Here, the first shape set in advance is temporarily set as the destruction range. The first shape is a shape the entirety of which is a curved surface, and for example, is an ellipsoidal body asymmetrical in the left-right direction. If the destruction action in the obliquely upward direction of the player character PC hits the terrain object 220, the destruction range having the second shape is temporarily set at a position in the field voxel space. The size of the destruction range varies in accordance with the object hit by the destruction action. For example, if the destruction action hits the terrain object (210 or 220), the destruction range having the first size is temporarily set. If the destruction action hits the enemy object EC, the destruction range having the second size smaller than the first size is temporarily set. After step S23, the process of step S24 is executed.

In step S24, the processor 81 determines whether or not the player character PC is in contact with the ground. If the player character PC is in contact with the ground, next, the process of step S25 is executed. If, on the other hand, the player character PC is not in contact with the ground, next, the process of step S26 is executed.

In step S25, the processor 81 calculates the height of and a normal to a surface on the ground with which the player character PC is in contact (a grounding surface) in the game space. For example, based on normal vectors at a plurality of reference points in a predetermined range including the position on the ground with which the player character PC is in contact (a grounding point), the processor 81 calculates the normal to the grounding surface. For example, the processor 81 calculates the average of the plurality of normal vectors as a normal vector of the grounding surface. Based on the height (the Y-axis coordinate value) of the grounding point, the processor 81 calculates the height of the grounding surface. For example, the processor 81 calculates the Y-axis coordinate value of the grounding point as the height of the grounding surface. The processor 81 may calculate the Y-axis coordinate value of the highest (or lowest) point in the predetermined range including the grounding point as the height of the grounding surface. The processor 81 may calculate the height of the grounding surface based on the average of the heights of the plurality of reference points. After step S25, the process of step S27 is executed.

In step S26, the processor 81 calculates the height of and a normal to the ground immediately below the player character PC. For example, the processor 81 calculates an intersection point between a straight line passing through the position of the player character PC and parallel to the Y-axis and the ground. Then, the processor 81 regards the intersection point as the above grounding point and calculates the height of and the normal to the ground immediately below the player character PC by a method similar to that in step S25. After step S26, the process of step S27 is executed.

In step S27, the processor 81 sets a predetermined surface. For example, if the destruction action in the front direction is performed, based on the height and the normal calculated in step S25 or step S26, the processor 81 sets the predetermined surface in the voxel space relating to the object hit by the destruction action. Specifically, if the destruction action in the front direction of the player character PC hits the terrain object 220, the predetermined surface having the normal calculated in step S25 or step S26 is set in the field voxel space. Consequently, for example, if the ground with which the player character PC is in contact or the ground immediately below the player character PC is a flat surface parallel to a horizontal plane, the flat surface parallel to the horizontal plane is set as the predetermined surface. The height of the predetermined surface is set to the same height as that of the ground. If the ground with which the player character PC is in contact or the ground immediately below the player character PC is tilted to the horizontal plane by a predetermined angle, a flat surface having the predetermined angle to the horizontal plane is set as the predetermined surface. In this case, the predetermined surface is set to pass through the position on the ground with which the player character PC is in contact or the position immediately below the player character PC. Alternatively, the predetermined surface may be set to pass through the highest (or lowest) point in a predetermined range including the position on the ground with which player character PC is in contact or the position immediately below the player character PC. As described above, if the ground itself is tilted, the predetermined surface is tilted in accordance with the tilt of the ground.

If the destruction action in the obliquely upward direction is performed, in step S27, the processor 81 sets the predetermined surface tilted to the horizontal plane in the field voxel space. For example, if the destruction action in the obliquely upward direction is performed, the predetermined surface tilted to the horizontal plane at an angle set in advance may be set. The predetermined surface is set to pass through the position on the ground with which the player character PC is in contact or the position immediately below the player character PC. Alternatively, the predetermined surface may be set to pass through the highest (or lowest) point in a predetermined range including the position on the ground with which the player character PC is in contact or the position immediately below the player character PC. The tilt of the predetermined surface may change in accordance with an operation of the player. For example, if the angle of the destruction action can be adjusted in accordance with an operation of the player, the tilt of the predetermined surface may change in accordance with the angle of the destruction action. As described above, the predetermined surface is tilted in accordance with the direction of the destruction action.

In a case where the ground itself is tilted to the horizontal plane, and if the destruction action in the obliquely upward direction is performed, the processor 81 sets the tilt of the predetermined surface in accordance with the tilt of the ground and/or the direction of the destruction action. For example, in a case where the ground itself is tilted, and if the destruction action in the obliquely upward direction is performed, the predetermined surface may be tilted in accordance with only either one of the tilt of the ground and the direction of the destruction action. For example, the tilt of the predetermined surface may be set by giving priority to the direction of the destruction action over the tilt of the ground itself. For example, in a case where the ground itself is tilted, and if the destruction action in the front direction is performed, the predetermined surface may be set to be parallel to the horizontal plane. The tilt of the predetermined surface may be set by giving priority to the tilt of the ground itself over the direction of the destruction action. For example, in a case where the ground itself is tilted, and if the destruction action in the front direction is performed, the predetermined surface may be tilted at the same angle as that of the ground (or at an angle different from that of the ground). If the tilt of the ground itself is greater than or equal to a predetermined value, the predetermined surface may be tilted in accordance with the tilt of the ground itself by giving priority to the tilt of the ground itself over the direction of the destruction action. If the tilt of the ground itself is less than the predetermined value, the predetermined surface may be tilted in accordance with the direction of the destruction action (the destruction action in the obliquely upward direction) by giving priority to the direction of the destruction action over the tilt of the ground itself. In a case where the ground itself is tilted, and if the destruction action in the obliquely upward direction is performed, the predetermined surface may be tilted in accordance with the tilt of the ground as described above, and the predetermined surface may be further tilted in accordance with the direction of the destruction action.

After step S27, the process of step S28 is executed.

In step S28, the processor 81 determines whether or not the predetermined surface set in step S27 is included in the first shape or the second shape set in step S23. Here, it is determined whether or not the set first shape or second shape and the predetermined surface intersect each other. In other words, it is determined whether or not a part of the first shape or the second shape is located below the predetermined surface. If the result of the determination in step S28 is affirmative, next, the process of step S29 is executed. If, on the other hand, the result of the determination in step S28 is negative, next, the process of step S30 is executed.

In step S29, the processor 81 sets a shape obtained by excluding a part below the predetermined surface from the first shape or the second shape as the destruction range and stores the destruction range as the destruction range data in the memory. Consequently, a shape of which the bottom surface is a flat surface is determined as the destruction range.

In step S30, since the first shape or the second shape is located above the predetermined surface, the processor 81 sets the first shape or the second shape as the destruction range and stores the destruction range as the destruction range data in the memory. Consequently, the first shape or the second shape the entirety of which is a curved surface is determined as the destruction range.

After the process of step S29 or step S30 is performed, the processor 81 ends the process shown in FIG. 31.

The processes shown in the above flow charts are merely illustrative, and the order and the contents of the processes, and the like may be appropriately changed.

As described above, in the exemplary embodiment, the player character PC can move on a terrain object formed based on voxel data and destroy the terrain object by the destruction action. If the destruction action hits the terrain object, a destruction range that is a range set in accordance with the position of the player character PC and has a shape obtained by excluding from a predetermined shape a range below a predetermined surface set based on the position of the player character PC is set. Then, voxel data of a voxel included in the destruction range is set to a value indicating that an object is not present. Consequently, the terrain object in the destruction range is destroyed. The destruction range is set as described above, whereby the terrain after the destruction has a shape along the predetermined surface, and it is possible to make it easy for the player character PC to move on the terrain after the destruction.

In the exemplary embodiment, if the player character PC performs the destruction action in an obliquely upward direction, the predetermined shape is set at a position in the obliquely upward direction of the player character PC, and the predetermined surface obliquely tilted is also set. Consequently, it is possible to make the terrain after the destruction oblique, and it is possible to form the terrain after the destruction along the direction of the destruction action.

In the exemplary embodiment, if a part of the predetermined shape is below the predetermined surface, a shape obtained by excluding the part below the predetermined surface from the predetermined shape is set as the destruction range. If the entirety of the predetermined shape is above the predetermined surface, the predetermined shape is set as the destruction range. Consequently, it is possible to dynamically set the destruction range in accordance with the situation of the game.

In the exemplary embodiment, if the player character PC is in the air when the destruction action hits the terrain object, the predetermined surface is set based on the ground immediately below the player character PC. Consequently, even if the player character PC is in the air, it is possible to make it easy for the player character PC to move on the terrain after the destruction.

In the exemplary embodiment, if the destruction action of the player character PC hits the terrain object, the destruction range having a first size is set. If the destruction action of the player character PC hits the enemy object EC, the destruction range having a second size smaller than the first size is set. Consequently, it is possible to destroy the terrain object in a large scale, while it is possible to destroy the enemy object in a small range.

In the exemplary embodiment, the size of a single voxel in the voxel space VLa for representing the enemy object in the game space is smaller than the size of a single voxel in the field voxel space in the game space for representing a terrain object. That is, the resolution of a voxel in the voxel space VLa for representing the enemy object is higher than the resolution of a voxel in the field voxel space for representing the terrain object. Thus, it is possible to represent the enemy object more finely than the terrain object.

### (Variations)

While the exemplary embodiment has been described above, the exemplary embodiment is merely an example and may be modified as follows, for example.

For example, in the above exemplary embodiment, if the destruction action of the player character PC hits a voxel object, the predetermined shape is set in a voxel space, and the predetermined surface is also calculated. Then, a shape obtained by excluding a part below the predetermined surface from the predetermined shape is set as the destruction range. That is, in the above exemplary embodiment, in accordance with the position of the player character PC when the destruction action of the player character PC hits an object, the predetermined surface is dynamically calculated. In another exemplary embodiment, a solid having a shape obtained by excluding a part below the predetermined surface from the predetermined shape may be prepared in advance. For example, a plurality of solids having shapes obtained by cutting the lower side of a sphere or an ellipsoidal body at flat surfaces may be prepared in advance. For example, a solid obtained by cutting the sphere or the ellipsoidal body at a flat surface located above the lower end of the sphere or the ellipsoidal body by a first distance, and a solid obtained by cutting the sphere or the ellipsoidal body at a flat surface located above the lower end of the sphere or the ellipsoidal body by a second distance may be prepared in advance. Then, any of the plurality of solids prepared in advance may be selected based on the position of the player character PC when the destruction action hits an object, and a range surrounded by the selected solid may be set as the destruction range.

That is, “a shape obtained by excluding a range below the predetermined surface from the predetermined shape” may be a shape calculated in accordance with the position of the player character PC or the situation of the ground when the destruction action hits an object, or may be a shape prepared in advance and selected in accordance with the position of the player character PC or the situation of the ground.

In the above exemplary embodiment, the player character PC performs the destruction action on the terrain object 220 representing a rock pile. In another exemplary embodiment, the destruction action may be performed on any other object. Also in this case, for example, if the destruction action in the front direction hits the object, the predetermined shape is set in accordance with the position hit by the destruction action, the predetermined surface is also set in accordance with the position of the player character PC, and a shape obtained by excluding a range below the predetermined surface from the predetermined shape is set as the destruction range. The size of the predetermined shape may differ in accordance with the object hit by the destruction action.

In the above exemplary embodiment, the predetermined shape is the same, regardless of the object hit by the destruction action, and the size of the predetermined shape differs. In another exemplary embodiment, the predetermined shape may differ in accordance with the object hit by the destruction action.

In the above exemplary embodiment, the direction of the destruction action of the player character PC is any of the front direction, the obliquely upward direction, and the down direction. In another exemplary embodiment, the destruction action of the player character PC may be performed in any direction.

In the above exemplary embodiment, when the destruction action hits an object, the predetermined surface as a flat surface is set based on the ground with which the player character PC is in contact or the ground immediately below the player character PC. In another exemplary embodiment, the predetermined surface may not be a completely flat surface. For example, the predetermined surface may be an approximately flat surface having small unevenness. The predetermined surface may change in accordance with the shape of the ground in the game space. For example, if the ground is an approximately flat surface having small unevenness, the predetermined surface may also be similar to the ground.

In the above exemplary embodiment, if the player character PC is in the air when the destruction action hits an object, the predetermined surface is set based on the ground immediately below the player character PC. In another exemplary embodiment, if the player character PC is in the air, the predetermined surface may be set not only immediately below the player character PC, but also based on the ground below the player character PC and in a predetermined direction from the position of the player character PC. For example, if the player character PC is in the air when the destruction action hits an object, the drop position of the player character PC may be predicted based on the moving direction of the player character PC, and the predetermined surface may be set based on the ground at the drop position.

In the above exemplary embodiment, the density of a voxel in the destruction range is set to “0”, thereby setting a value indicating that an object is not present in the voxel. Consequently, a portion in the destruction range in a voxel object is erased, and the voxel object is destroyed. The destruction (erasure) of the voxel object may be set not only by setting the density of voxel data to “0”, but also by setting the density to another value. For example, regarding the density, “a value indicating that an object is not present” may not be limited to “0”, and may be any value less than a reference value (e.g., 128). Regarding the density, “a value indicating that an object is present” may be a value in the range from 1 to 255, or may be a value greater than or equal to the reference value. The destruction of a voxel object may be performed not only by changing the density of voxel data, but also by another method. For example, a flag indicating the presence or absence of an object may be stored in voxel data, and if the flag is set to ON, it may be indicated that an object is present in the voxel. If the flag is set to OFF, it may be indicated that an object is not present in the voxel (e.g., a cavity). If the material data is stored in voxel data, it may be indicated that an object formed of the material indicated by the material data is present in the voxel. Conversely, if the material data is not stored in voxel data, it may be indicated that an object is not present in the voxel.

The above processes may be executed not only by the game system 1 but also by any other information processing apparatus or information processing system. The information processing system may include a plurality of apparatuses, and the plurality of apparatuses may be connected together via a network (e.g., a LAN, the Internet, or the like).

The configurations of the above exemplary embodiment and its variations can be optionally combined together unless they contradict each other. Further, the above description is merely an example of the exemplary embodiment, and may be improved and modified in various manners other than the above.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable media having stored therein instructions that, when executed, cause one or more processors of an information processing apparatus to execute image processing comprising:
storing, in a memory, first volume data that is data for representing a first object in a virtual space and holds voxel data indicating presence of an object with respect to each voxel included in a first voxel space placed in the virtual space;
moving a player character on the first object based on an operation input of a player;
causing the player character to perform a destruction action based on an operation input of the player;
if the destruction action hits the first object, updating the voxel data of a voxel included in a first erasure range to a value indicating that an object is not present, the first erasure range being a range set in accordance with a position of the player character and having a shape obtained by excluding from a predetermined shape a range below a predetermined surface set based on the position of the player character; and
based on the first volume data, at least drawing a polygon mesh representing a surface of the first object, thereby generating an image of the virtual space.

2. The one or more non-transitory computer-readable media according to claim 1, wherein
the destruction action is a destruction action in a front direction of the player character,
the first erasure range is set in front of the player character when the destruction action hits the first object, and
the predetermined surface is a horizontal plane having a height of a ground with which the player character is in contact when the destruction action hits the first object.

3. The one or more non-transitory computer-readable media according to claim 1, wherein
the image processing further comprises, if the destruction action hits the first object, setting a height of the predetermined surface based on the position of the player character, and
if the entirety of the predetermined shape is located above the predetermined surface, the first erasure range is the predetermined shape.

4. The one or more non-transitory computer-readable media according to claim 1, wherein
the destruction action is a destruction action in a front direction of the player character,
the first erasure range is set in front of the player character when the destruction action hits the first object, and
if the player character is in the air when the destruction action hits the first object, the predetermined surface is a horizontal plane having a height of a ground located below the player character.

5. The one or more non-transitory computer-readable media according to claim 1, wherein
the destruction action is a destruction action in an obliquely upward direction of the player character,
the first erasure range is set in the obliquely upward direction of the player character when the destruction action hits the first object, and
the predetermined surface is a slope which passes through a position on a ground with which the player character is in contact when the destruction action hits the first object, and in which the further in a forward direction of the player character the slope is, the higher the slope is.

6. The one or more non-transitory computer-readable media according to claim 1, wherein
the predetermined shape is any of a sphere, an ellipsoidal body, and a shape obtained by asymmetrically deforming an ellipsoidal body.

7. The one or more non-transitory computer-readable media according to claim 1, wherein
the image processing further comprises, if a ground with which the player character is in contact when the destruction action hits the first object is tilted to a horizontal plane, setting the predetermined surface tilted to the horizontal plane.

8. The one or more non-transitory computer-readable media according to claim 1, wherein
the image processing further comprises:
storing, in the memory, second volume data that is data for representing a second object in the virtual space and holds the voxel data with respect to each voxel included in a second voxel space placed in the virtual space;
if the destruction action hits the second object, updating the voxel data of a voxel included in a second erasure range that is a range set in accordance with the position of the player character, has a shape obtained by excluding from a predetermined shape a range below a predetermined surface set based on the position of the player character, and is different in size from the first erasure range to a value indicating that an object is not present; and
further drawing a polygon mesh representing a surface of the second object based on the second volume data, thereby generating an image of the virtual space.

9. The one or more non-transitory computer-readable media according to claim 8, wherein
a single voxel included in the first volume data and a single voxel included in the second volume data are different from each other in size defined in the virtual space.

10. The one or more non-transitory computer-readable media according to claim 1, wherein
the image processing further comprises:
causing the player character to perform a destruction action in a down direction based on an operation input of the player, and
if the destruction action in the down direction hits the first object, updating the voxel data of a voxel included in a third erasure range set below the player character to a value indicating that the first object is not present.

11. The one or more non-transitory computer-readable media according to claim 1, wherein
the first object is a terrain in the virtual space.

12. The one or more non-transitory computer-readable media according to claim 1, wherein
the image processing further comprises:
determining a vertex position of a polygon based on the voxel data between a voxel in which the first object is not present and a voxel in which the first object is present, thereby generating the polygon mesh; and
if the voxel data of a voxel included in the first erasure range is updated, recalculating a vertex of the polygon mesh in a range including a voxel in which at least the voxel data is updated.

13. An information processing system comprising: one or more processors that are configured to execute image processing comprising:
storing in a memory
first volume data that is data for representing a first object in a virtual space and holds voxel data indicating presence of an object with respect to each voxel included in a first voxel space placed in the virtual space;
moving a player character on the first object based on an operation input of a player;
causing the player character to perform a destruction action based on an operation input of the player;
if the destruction action hits the first object, updating the voxel data of a voxel included in a first erasure range to a value indicating that an object is not present, the first erasure range being a range set in accordance with a position of the player character and having a shape obtained by excluding from a predetermined shape a range below a predetermined surface set based on the position of the player character; and
based on the first volume data, at least drawing a polygon mesh representing a surface of the first object, thereby generating an image of the virtual space.

14. The information processing system according to claim 13, wherein
the destruction action is a destruction action in a front direction of the player character,
the first erasure range is set in front of the player character when the destruction action hits the first object, and
the predetermined surface is a horizontal plane having a height of a ground with which the player character is in contact when the destruction action hits the first object.

15. The information processing system according to claim 13, wherein
the image processing further comprises:
if the destruction action hits the first object, setting a height of the predetermined surface based on the position of the player character; and
if the entirety of the predetermined shape is located above the predetermined surface, setting the predetermined shape as the first erasure range.

16. The information processing system according to claim 13, wherein
the destruction action is a destruction action in a front direction of the player character,
the first erasure range is set in front of the player character when the destruction action hits the first object, and
if the player character is in the air when the destruction action hits the first object, the predetermined surface is a horizontal plane having a height of a ground located below the player character.

17. The information processing system according to claim 13, wherein
the destruction action is a destruction action in an obliquely upward direction of the player character,
the first erasure range is set in the obliquely upward direction of the player character when the destruction action hits the first object, and
the predetermined surface is a slope which passes through a position on a ground with which the player character is in contact when the destruction action hits the first object, and in which the further in a forward direction of the player character the slope is, the higher the slope is.

18. The information processing system according to claim 13, wherein
the predetermined shape is any of a sphere, an ellipsoidal body, and a shape obtained by asymmetrically deforming an ellipsoidal body.

19. The information processing system according to claim 13, wherein
the image processing further comprises, if a ground with which the player character is in contact when the destruction action hits the first object is tilted to a horizontal plane, setting the predetermined surface tilted to the horizontal plane.

20. The information processing system according to claim 13, wherein
the image processing further comprises:
storing in a memory, second volume data that is data for representing a second object in the virtual space and holds the voxel data with respect to each voxel included in a second voxel space placed in the virtual space;
if the destruction action hits the second object, updating the voxel data of a voxel included in a second erasure range that is a range set in accordance with the position of the player character, has a shape obtained by excluding from a predetermined shape a range below a predetermined surface set based on the position of the player character, and is different in size from the first erasure range to a value indicating that an object is not present; and
further drawing a polygon mesh representing a surface of the second object based on the second volume data, thereby generating an image of the virtual space.

21. The information processing system according to claim 20, wherein
a single voxel included in the first volume data and a single voxel included in the second volume data are different from each other in size defined in the virtual space.

22. The information processing system according to claim 13, wherein
the image processing further comprises:
causing the player character to perform a destruction action in a down direction based on an operation input of the player, and
if the destruction action in the down direction hits the first object, updating the voxel data of a voxel included in a third erasure range set below the player character to a value indicating that the first object is not present.

23. The information processing system according to claim 13, wherein
the first object is a terrain in the virtual space.

24. The information processing system according to claim 13 wherein
the image processing further comprises:
determining a vertex position of a polygon based on the voxel data between a voxel in which the first object or the second object is not present and a voxel in which the first object or the second object is present, thereby generating the polygon mesh; and
if the voxel data of a voxel included in the first erasure range is updated, recalculating a vertex of the polygon mesh in a range including a voxel in which at least the voxel data is updated.

25. An information processing apparatus comprising: one or more processors that are configured to execute image processing comprising:
storing in a memory
first volume data that is data for representing a first object in a virtual space and holds voxel data indicating presence of an object with respect to each voxel included in a first voxel space placed in the virtual space;
moving a player character on the first object based on an operation input of a player;
causing the player character to perform a destruction action based on an operation input of the player;
if the destruction action hits the first object, updating the voxel data of a voxel included in a first erasure range to a value indicating that an object is not present, the first erasure range being a range set in accordance with a position of the player character and having a shape obtained by excluding from a predetermined shape a range below a predetermined surface set based on the position of the player character; and
based on the first volume data, at least drawing a polygon mesh representing a surface of the first object, thereby generating an image of the virtual space.

26. The information processing apparatus according to claim 25, wherein
the destruction action is a destruction action in a front direction of the player character,
the first erasure range is set in front of the player character when the destruction action hits the first object, and
the predetermined surface is a horizontal plane having a height of a ground with which the player character is in contact when the destruction action hits the first object.

27. The information processing apparatus according to claim 25, wherein
the image processing further comprises:
if the destruction action hits the first object, setting a height of the predetermined surface based on the position of the player character; and
if the entirety of the predetermined shape is located above the predetermined surface, setting the predetermined shape as the first erasure range.

28. The information processing apparatus according to claim 25, wherein
the destruction action is a destruction action in a front direction of the player character,
the first erasure range is set in front of the player character when the destruction action hits the first object, and
if the player character is in the air when the destruction action hits the first object, the predetermined surface is a horizontal plane having a height of a ground located below the player character.

29. The information processing apparatus according to claim 25, wherein
the destruction action is a destruction action in an obliquely upward direction of the player character,
the first erasure range is set in the obliquely upward direction of the player character when the destruction action hits the first object, and
the predetermined surface is a slope which passes through a position on a ground with which the player character is in contact when the destruction action hits the first object, and in which the further in a forward direction of the player character the slope is, the higher the slope is.

30. The information processing apparatus according to claim 25, wherein
the predetermined shape is any of a sphere, an ellipsoidal body, and a shape obtained by asymmetrically deforming an ellipsoidal body.

31. An information processing method performed by an information processing system,
wherein the information processing system stores first volume data that is data for representing a first object in a virtual space and holds voxel data indicating presence of an object with respect to each voxel included in a first voxel space placed in the virtual space,
the information processing method comprising:
moving a player character on the first object based on an operation input of a player;
causing the player character to perform a destruction action based on an operation input of the player;
if the destruction action hits the first object, updating the voxel data of a voxel included in a first erasure range to a value indicating that an object is not present, the first erasure range being a range set in accordance with a position of the player character and having a shape obtained by excluding from a predetermined shape a range below a predetermined surface set based on the position of the player character; and
based on the first volume data, at least drawing a polygon mesh representing a surface of the first object, thereby generating an image of the virtual space.

32. The information processing method according to claim 31, wherein
the destruction action is a destruction action in a front direction of the player character,
the first erasure range is set in front of the player character when the destruction action hits the first object, and
the predetermined surface is a horizontal plane having a height of a ground with which the player character is in contact when the destruction action hits the first object.

33. The information processing method according to claim 31, further comprising:
if the destruction action hits the first object, setting a height of the predetermined surface based on the position of the player character, and
if the entirety of the predetermined shape is located above the predetermined surface, setting the predetermined shape as the first erasure range.

34. The information processing method according to claim 31, wherein
the destruction action is a destruction action in a front direction of the player character,
the first erasure range is set in front of the player character when the destruction action hits the first object, and
if the player character is in the air when the destruction action hits the first object, the predetermined surface is a horizontal plane having a height of a ground located below the player character.

35. The information processing method according to claim 31, wherein
the destruction action is a destruction action in an obliquely upward direction of the player character,
the first erasure range is set in the obliquely upward direction of the player character when the destruction action hits the first object, and
the predetermined surface is a slope which passes through a position on a ground with which the player character is in contact when the destruction action hits the first object, and in which the further in a forward direction of the player character the slope is, the higher the slope is.

36. The information processing method according to claim 31, wherein
the predetermined shape is any of a sphere, an ellipsoidal body, and a shape obtained by asymmetrically deforming an ellipsoidal body.
